(19) United States
(12) Patent Application Publication
(10) Pub. No.: US 2002/0103907 A1
(43) Pub. Date: Aug. 1, 2002

(54) System and method of storing data to a recording medium

(76) Inventor: Erik Petersen, Providence, RI (US)

Correspondence Address: Kevin R. Spivack, Morrison & Foerster LLP, Suite 5500, 2000 Pennsylvania Avenue, Washington, DC, 20006-1888, US

(21) Appl. No.: 09/884,437

(22) Filed: Jun. 20, 2001

Related U.S. Application Data
(60) Provisional application No. 60/212,076, filed on Jun. 20, 2000.

(51) Int. Cl. G06F 15/173

(52) U.S. Cl. 709/226

(57) ABSTRACT

The present invention seeks to utilize the unused portions of storage capacity on servers. Existing servers (e.g. vendor servers) are used to store data for backup purposes. Data stored therein is preferably dispersed amongst multiple servers, or can be limited to one server. When a customer requests storage space for backup of data, a central server monitoring the servers tied into the service will check the availability of storage space on the servers. The data will then be allocated to empty space in the various servers, selected according to, for example, bandwidth of transmission, availability, etc.

This application claims the benefit of priority to provisional application Serial No. 60/212,076, filed Jun. 20, 2000, which is hereby incorporated by reference.

### TECHNICAL FIELD OF THE INVENTION

The present invention relates to storing data on a recording medium, and in particular, to storing data on servers, for the purpose of backing up the data, and for the purpose of sharing the data with other users.

### BACKGROUND OF THE INVENTION

Computers and networks have been a part of our daily lives for a great many years. Most recently, however, consumers and businesses have begun to utilize computers and networks connected to, for example, the Internet and World Wide Web. The Internet is comprised of a set of networks connected by routers that are configured to pass traffic among any computers attached to networks in the set. In a typical scenario, a consumer may access the Internet using a personal computer connected through an Internet service provide (“ISP”). The ISP, for example AOL™, uses servers and databases to store information for providing users access to networks such as the Internet. Unlike storage devices attached to a personal computer, servers include a storage capacity that typically far exceeds the needs of an individual user. That is, most personal computer users do not have the need to purchase a personal server. However, users (and business for that matter) often require more data storage than a personal computer provides, especially due to the increasingly large size of programs. Hence, users are reluctant to use storage devices (e.g. hard drives) to keep files backed up.

Additionally, it is often preferred that the storage device not act as the main source for the storing, which is typically the case with hard drives on personal computers. While personal computers are scalable, adding a separate device to store data (e.g. tape drives or floppy drives) for backup purposes can add unnecessary costs to the home system, and often requires a substantial amount of time in order to store large amounts of data to these devices. On the other hand, businesses, such as ISPs, require large amounts of storage space. Servers typically provide this source of storage. Often times, however, ISPs fail to use the entire storage capacity of the server. Hence, there is a valuable commodity that goes unused.

Also, it is difficult for dispersed groups of people to share data that is stored on one computer, or at only one location. For example a national organization may want to share large video files for educational purposes, but they do not have the resources to acquire the servers and services necessary to supply those videos to the entire organization, which might be geographically dispersed. By using the invention, and allowing the entire organization access to the data stored on the invention, the data can be more easily shared, or collaborated upon.

### SUMMARY OF THE INVENTION

In one embodiment of the invention, there is a method of storing data on a network. The method includes, for example, identifying available resources located on a network; and allocating storage space on at least one identified resource on the network for storage of data.

In one aspect of the invention, the method further includes indicating the amount and location of resources available on the network; creating a file allocation table identifying the storage available on the network resources; and sending the file allocation table to the identified resources, and reserving storage space on a respective resource based on the file allocation table.

In another aspect of the invention, the method further includes searching for the data path to upload data based on at least one of latency, hop count and availability; discarding undesirable resource locations for uploading; and sending data to the identified resources for storage.

In another embodiment of the invention, there is a method of distributing data across a network. The method includes, for example, searching the network resources for available storage space; allocating network resources based on a file allocation table created as a result of the search; and sending the data to the allocated resources for storage.

In one aspect of the invention, the resources include servers connected to the network and the file allocation table includes at least information regarding the availability and location of the resources.

In still another embodiment of the invention, there is a method of retrieving data stored at multiple locations on a network. The method includes, for example, requesting a file allocation table including the location of stored data; searching for a data path to retrieve the data; sending a request to each location having data stored thereon; and reassembling the data at the multiple locations.

In one aspect of the invention, the data includes header information identifying at least where the data is to be sent.

In yet another embodiment of the invention, there is a method of storing data on a network at a different location from a client requesting storage. The method includes, for example, receiving data from a user server and examining header information in the data for instructions; replacing the header information with new header information; and sending the data over the network to at least one server identified on the network in the header information.

In another embodiment of the invention, there is a system for storing data over a network. The system includes, for example, a client requesting resources for storing data over the network; a central server processing the request from the client and allocating resources to the client for storing the data; and a vendor server for storing the data, the vendor server being selected by the central server based on the processing.

In one aspect of the invention, the central server identifies which vendor server has space available for storing the data, and the vendor server indicates to the central server the availability of space on the server.

In another aspect of the invention, the central server includes a file allocation table to store at least information about the availability and location of resources on the network for storing data, and the vendor server stores at least a first portion of the data, and another vendor server stores at least a second portion of the data.

In still another embodiment of the invention, there is a system for allocating resources on a network to store data. The system includes, for example, a plurality of servers to store data; and a central server identifying at least one of the plurality of servers to store the data, the plurality of servers residing at a location different from the location from which data storage is requested.

In one aspect of the invention, the system further includes a client requesting the storage of data on at least one of the plurality of servers located at a different location, the central server creating a file allocation table to store at least information about the availability and location of the plurality of servers.

In another aspect of the invention, the file allocation table is created based on information supplied by the plurality of servers to the central server.

In still another aspect of the invention, the vendor server is connected to a local network, the vendor server using resources on the local network for storage of the data.

### BRIEF DESCRIPTION OF THE DRAWINGS

FIG. 1a is an exemplary embodiment of the system architecture of the present invention.

FIG. 1b is an exemplary embodiment of an aggregation of storage device/servers for storage services in the present invention.

FIGS. 1c, 2 and 3 illustrate queries and reporting of available storage space of servers and by servers and devices

FIG. 4 illustrates servers forming a file allocation table identifying storage on the network.

FIG. 4a illustrates an exemplary file allocation table (FAT).

FIG. 4b illustrates FATs replicated on FAT servers.

FIG. 5 illustrates an exemplary network.

FIG. 5a illustrates system software residing on a server.

FIG. 6 illustrates a user request for storage services.

FIG. 7 illustrates servers sending a provisional FAT for allocating storage space.

FIG. 7a illustrates a user requesting storage space.

FIG. 8 illustrates a user and server searching for an optimum path to offload data.

FIG. 9 illustrates a server discarding server locations as undesirable for off loading.

FIG. 10 illustrates headers attached to data.

FIG. 11 illustrates a server sending data to other servers for storage.

FIG. 12 illustrates data received from a user server.

FIG. 12a illustrates sending data over a network to vendor servers.

FIG. 13a illustrates data received from one server to another server.

FIG. 13b illustrates a server reading instructions stored in a header.

FIG. 13c illustrates a server sending data to the network accessible devices for storage.

FIG. 13d illustrates network accessible devices on the network.

FIG. 13e illustrates a server receiving validation messages from network accessible devices.

FIG. 14 illustrates reporting of successful storage to the user.

FIG. 15 illustrates compilation of a final FAT.

FIG. 15a illustrates storage over a network.

FIG. 15b illustrates requesting storage from another server.

FIG. 15c illustrates over a private network.

FIG. 15d illustrates storage over a network.

FIG. 15e illustrates storage over a network.

FIG. 16 illustrates downloading of previously stored data.

FIG. 17 illustrates a server sending a receiving a FAT for locations of data.

FIG. 18 illustrates a user and server searching for the optimum path for downloading data.

FIG. 19 illustrates a server sending an authenticated, encrypted, secure request to servers storing data.

FIG. 20 illustrates a server sending a data validation message to vendor servers.

FIG. 21 illustrates a server sending another server the results of its download for reallocation of storage resources.

FIG. 22 illustrates a server notifying vendor servers of the data storage.

FIG. 23 illustrates a server validating that other servers stored data.

### DETAILED DESCRIPTION OF THE INVENTION

The present invention seeks to utilize the unused portions of storage capacity on system resources, such as servers. Existing servers (e.g. vendor servers) are used to store data for backup purposes. Data stored therein is preferably dispersed amongst multiple servers, or can be limited to one server. When a customer requests storage space for backup of data, a central server monitoring the servers tied into the service will check the availability of storage space on the servers. The data will then be allocated to empty space in the various servers, selected according to, for example, bandwidth of transmission, availability, etc.

Servers (e.g. vendor servers or ISP servers) are registered with a central server in order to allow users the ability to store information in the available storage on the servers. This available storage space acts, for example, as a supplemental storage device for the user. A user can be, for example, an individual or a business entity. Significantly, the user can add or remove storage space as necessary to fit his or her particular storage needs. The additional storage space may be read or written similar to a drive physically attached to the user's computer. Although the storage space may be found and allocated to more than one server, the user has the appearance of only one storage location. This is accomplished by using a central server, to which the servers are attached, as the “log-on” site for users to obtain additional storage space. The central server, for example, then monitors and allocates storage to the user as needed. Of course, storage is not limited from user (i.e., client)-to-server. For example, server-to-server storage may also be implemented, as may computer-to computer storage space. That is, computers could access other computers via the present invention for additional storage space, or a server could access another server via the present invention.

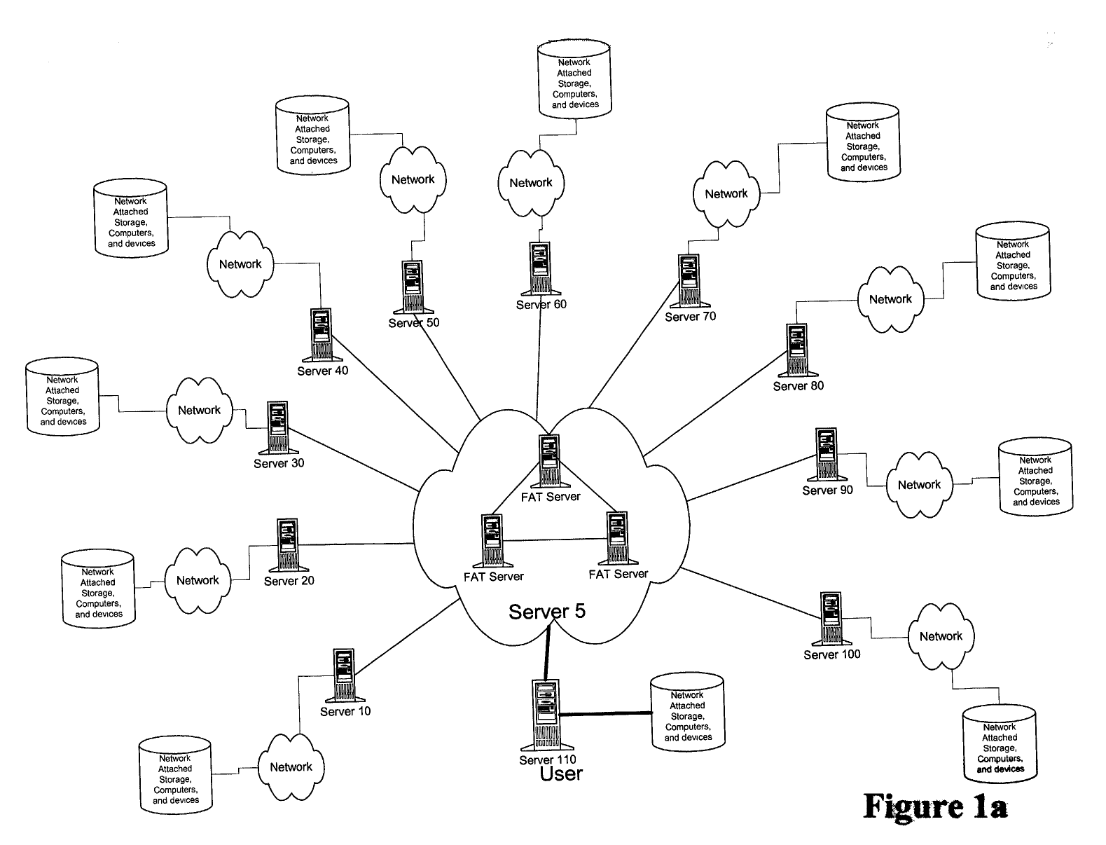

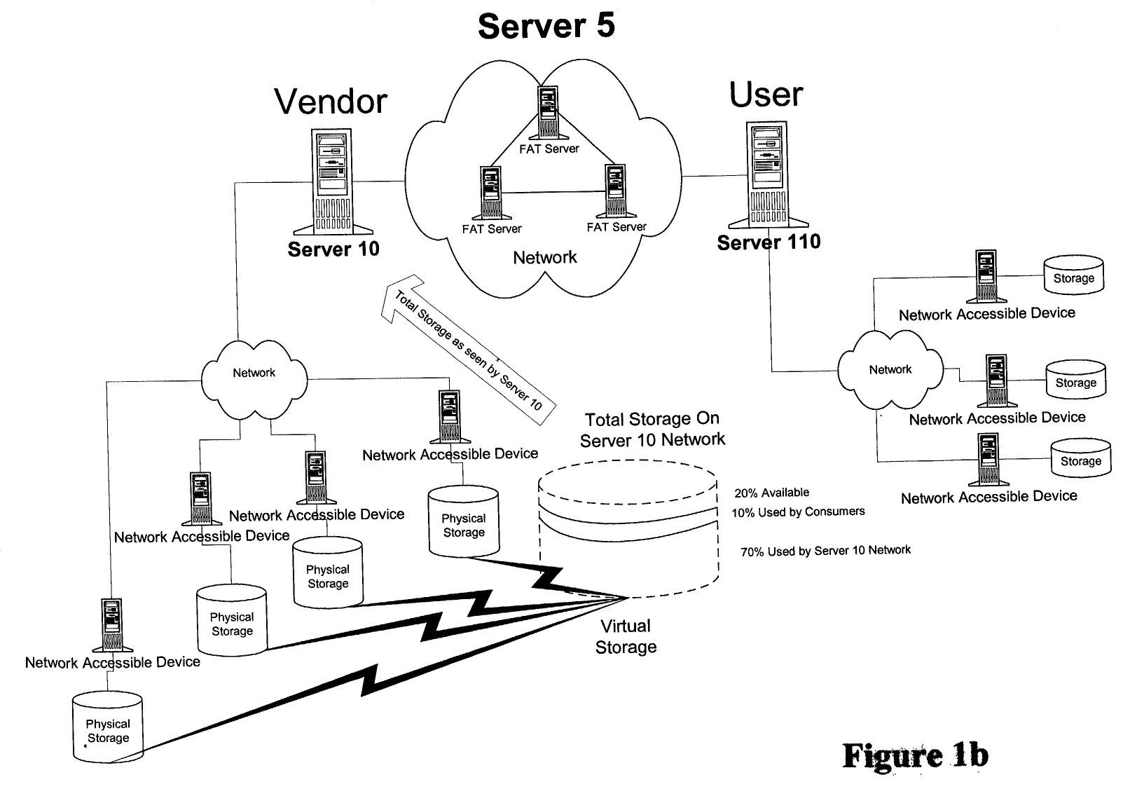

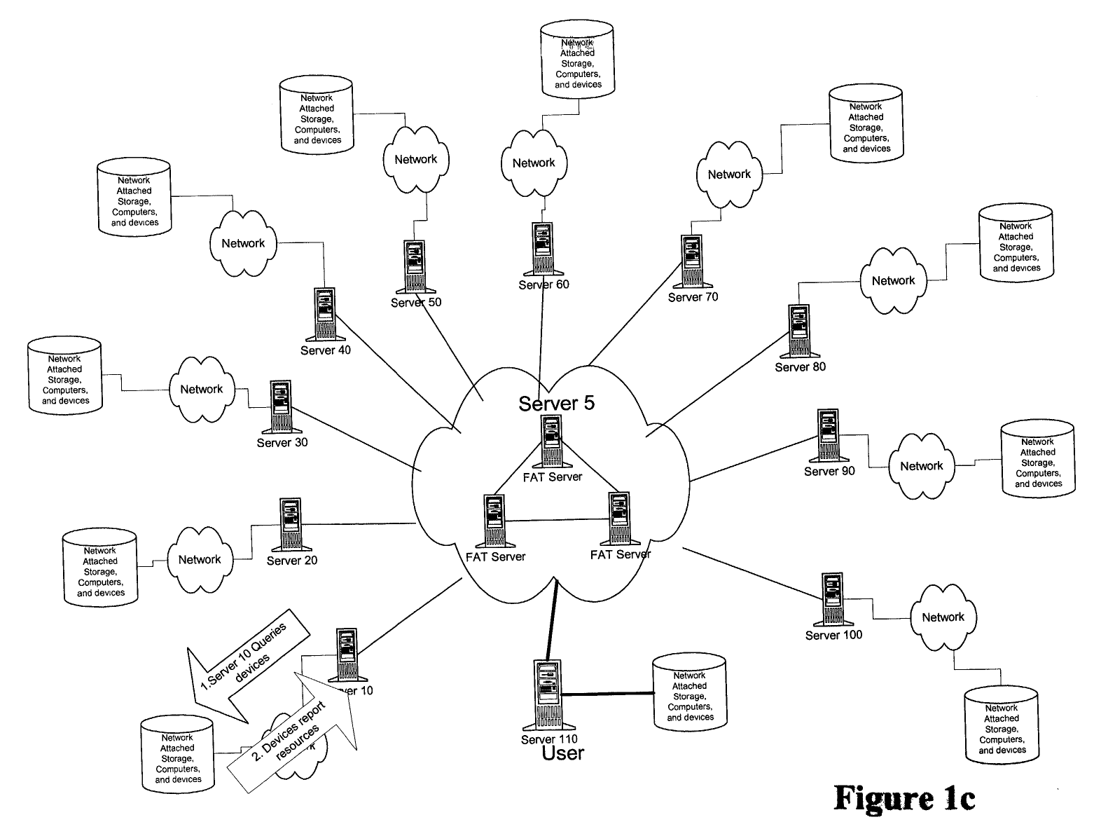

FIG. 1a illustrates an exemplary system diagram. The system includes, for example, servers 10-100 (e.g. vendor servers), central server 5 and users (e.g. clients) 110. In FIG. 1a, central server 5 is made up of 3 servers located across a network such as the Internet. Each of the 3 servers connects across a network to ensure availability of the functions of central server 5. The information is “mirrored” amongst the three servers, creating central server 5. Of course, more or less than 3 servers can be used as readily understood by one having ordinary skill in the art.

In one embodiment, the vendor servers 10 - 100 have software residing thereon to monitor the status of the available storage capacity. The software monitors available storage on networked attached devices on its local network. By monitoring the devices, the software learns how much total storage is available for storage and distribution on its local network. In an alternative embodiment, the network-attached devices will report their resources to the servers.

In an alternate embodiment, the central server 5 monitors the available storage capacity on the servers 10-100. Of course, one having ordinary skill in the area will recognize that the system is not limited to these embodiments. For example, as an alternative embodiment in FIG 1c, servers 10-100 monitor the storage capacity of each of servers 10-100, without the aid of central server 5.

In an alternative embodiment, no FAT servers are required. In this embodiment, a FAT “server-less” storage network would operate the same as the central FAT server embodiment except that the FAT tables would be compiled and shared by the storage servers (for example, the Internet File Servers-see FIG. 1c). Without the central FAT servers the embodiment is a peer-to-peer relationship. In either event, in order to properly monitor and allocate available server space, a table based on the participating servers is compiled. The table would include, for example, the domain names, IP addresses, network connection capacity, available storage capacity, etc. for each registered server. Essentially, the table will keep track of the individual servers, and track the space available on each server. When a user accesses the central server 5 to store (upload) information to a server with available space, the table is accessed to determine which of the registered servers has available storage capacity, as well as to determine which of the servers provides the quickest and most efficient transfer of data at that time. Data is then routed and stored to the appropriate server. Similarly, when a user wishes to access (download) information previously stored in a server, the table stored on the central server 5 is accessed to determine where the information was stored. A user can also share its access privileges to its user data with another trusted user, so that such a user can also access the data. Alternatively, a program could be stored on individual servers to monitor the available server space. The servers could then respond to queries from the central server 5 regarding available space.

Referring to FIG. 1b, the program (software) residing on each server monitors the status of each respective server. For example, a program residing on server 10 monitors the status of the available storage capacity on server 10, and on devices attached or available to server 10. As illustrated in FIG. 1b, the program may determine, for example, that 70% of the server network attached or available storage is being used by a vendor (e.g. an ISP), 10% of the server network available storage is being used by consumers registered with the service, and the remaining 20% is available.

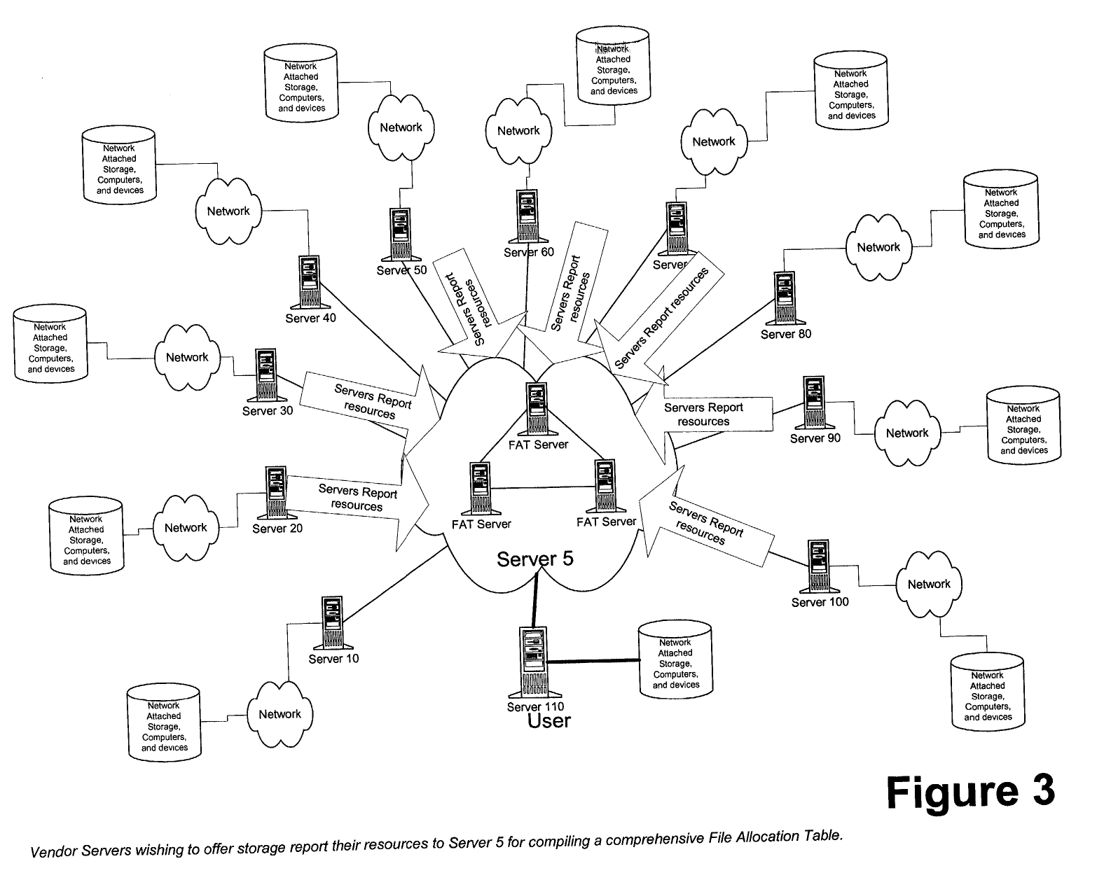

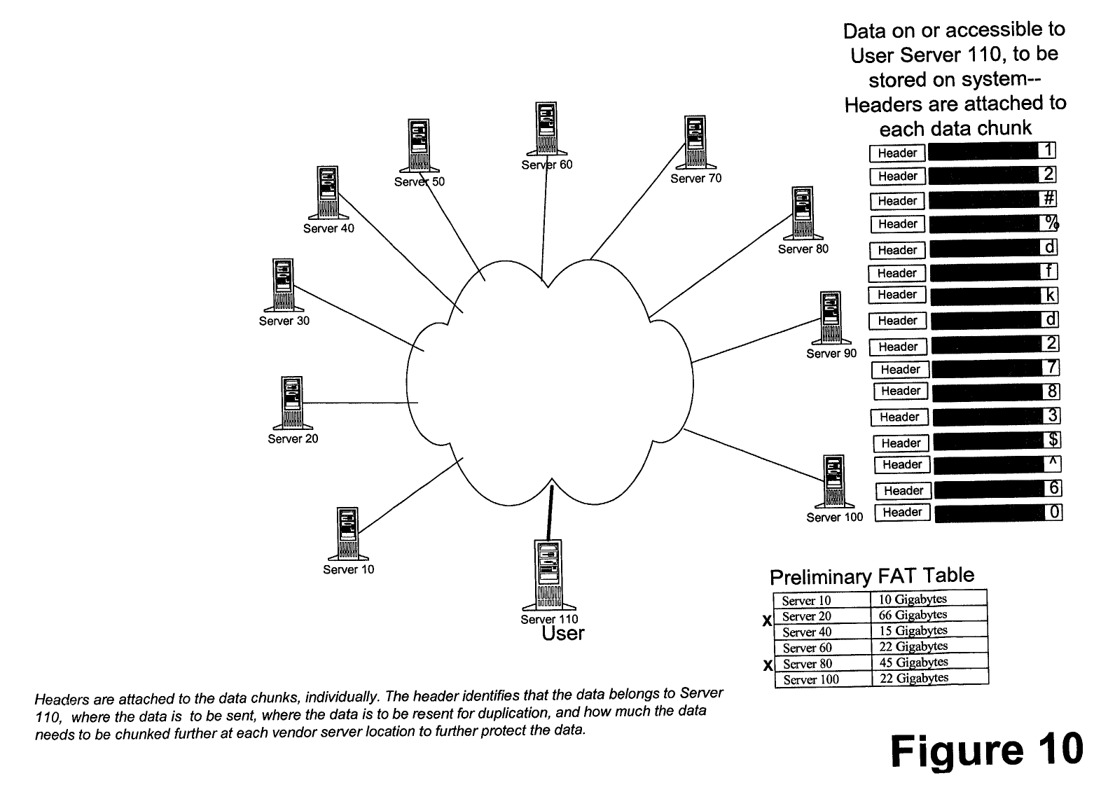

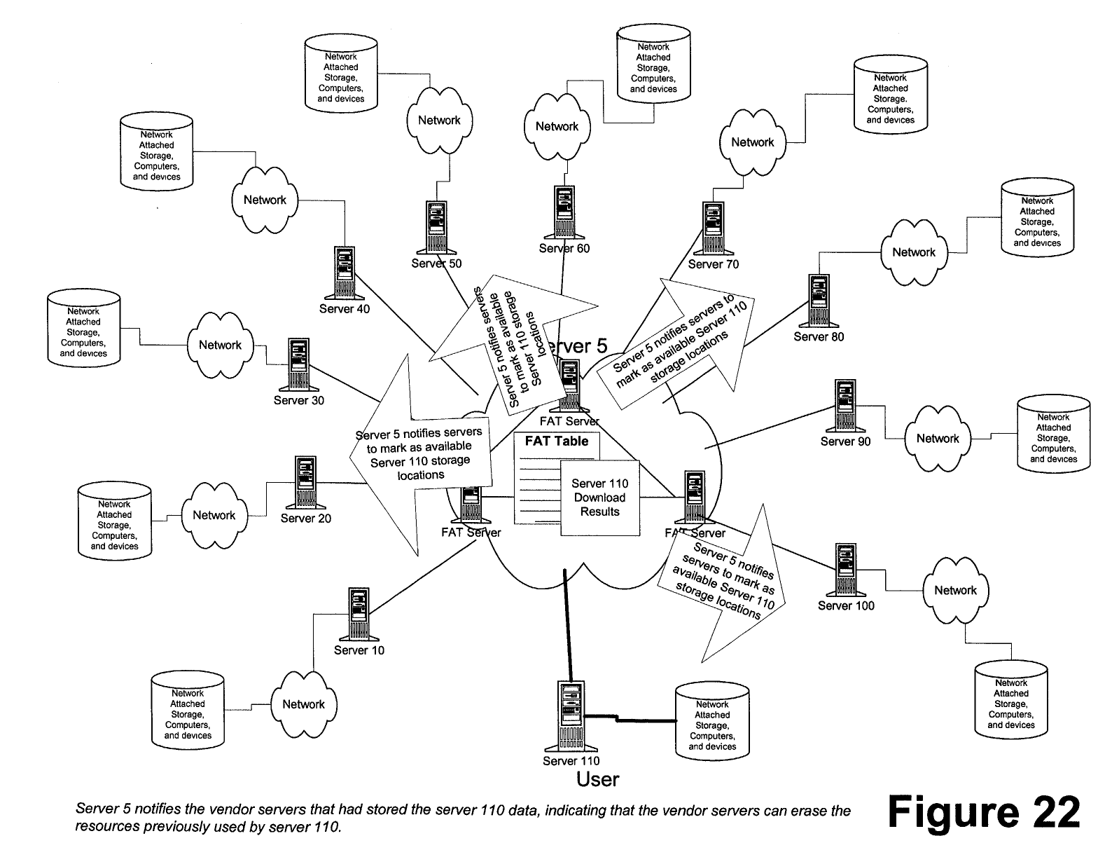

Referring to FIGS. 1a-23, the servers 10-100 are queried, on a random or predetermined basis, by the central server 5 to determine the availability of space on respective servers 10-100. The query determines whether a respective server is, for example, readable, full and/or determines the amount of capacity.

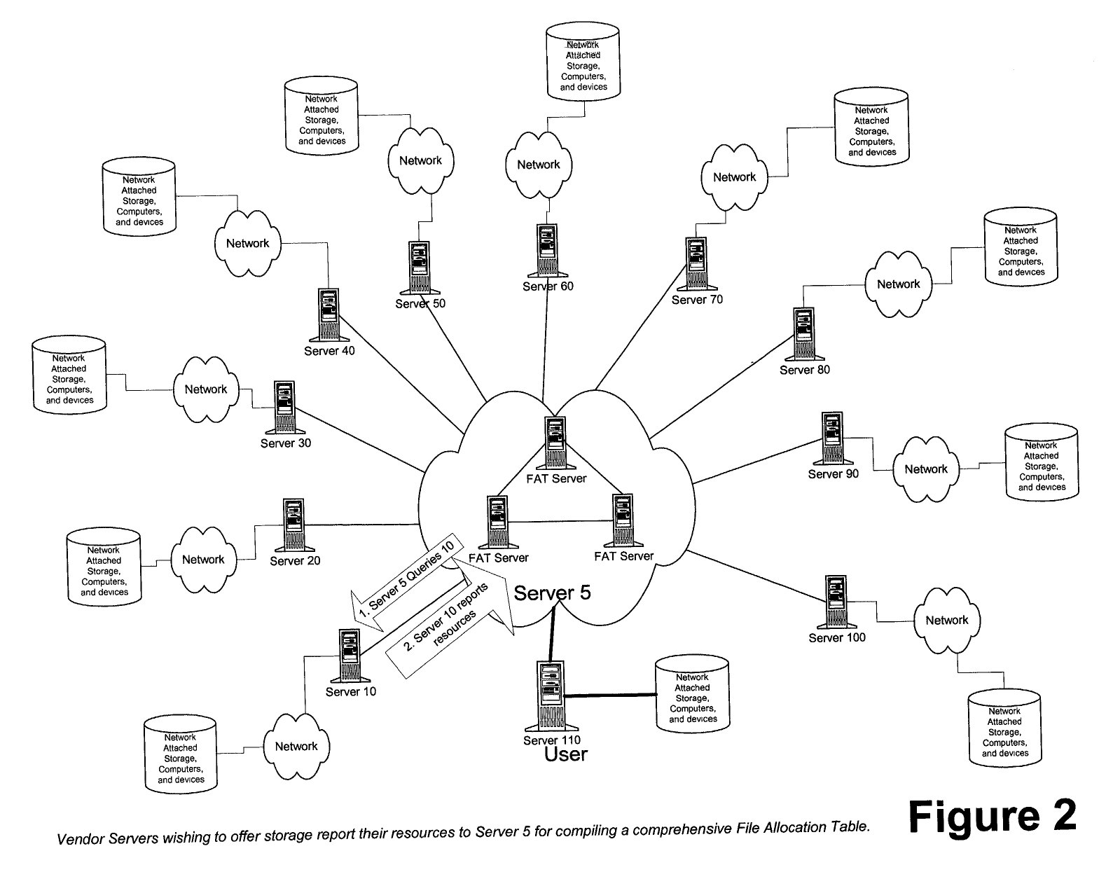

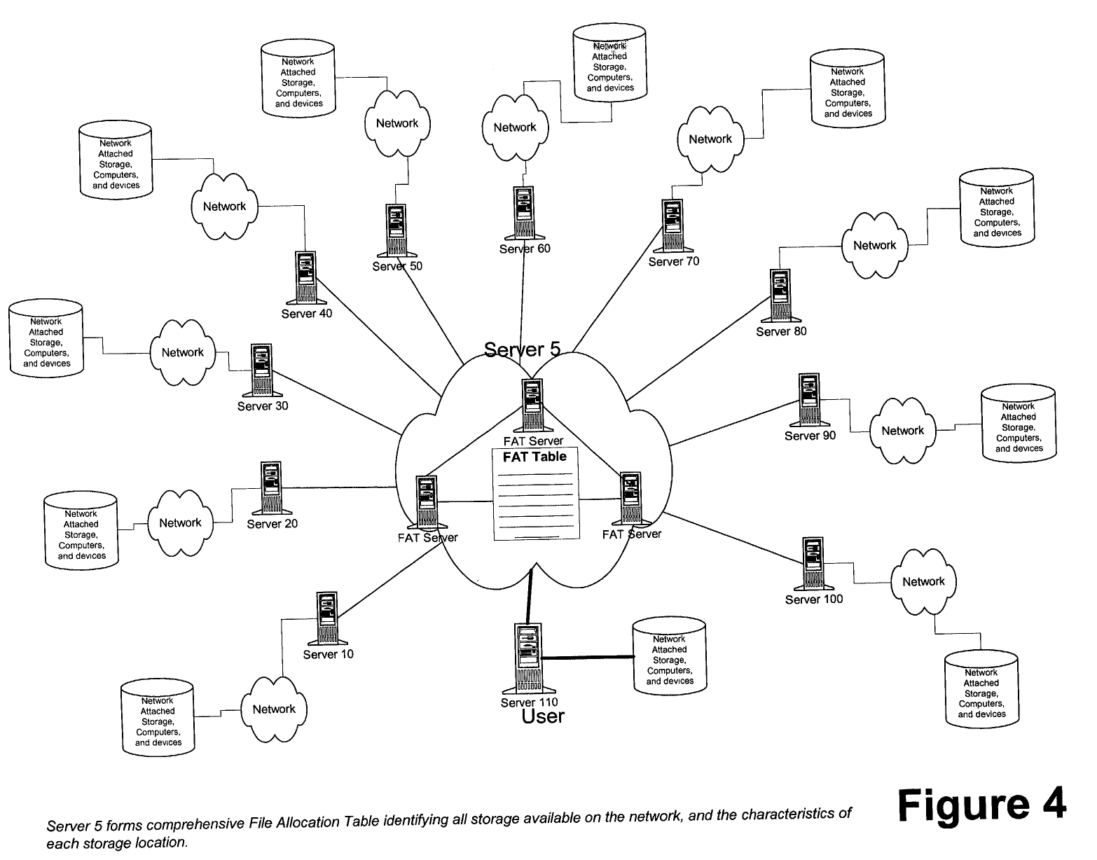

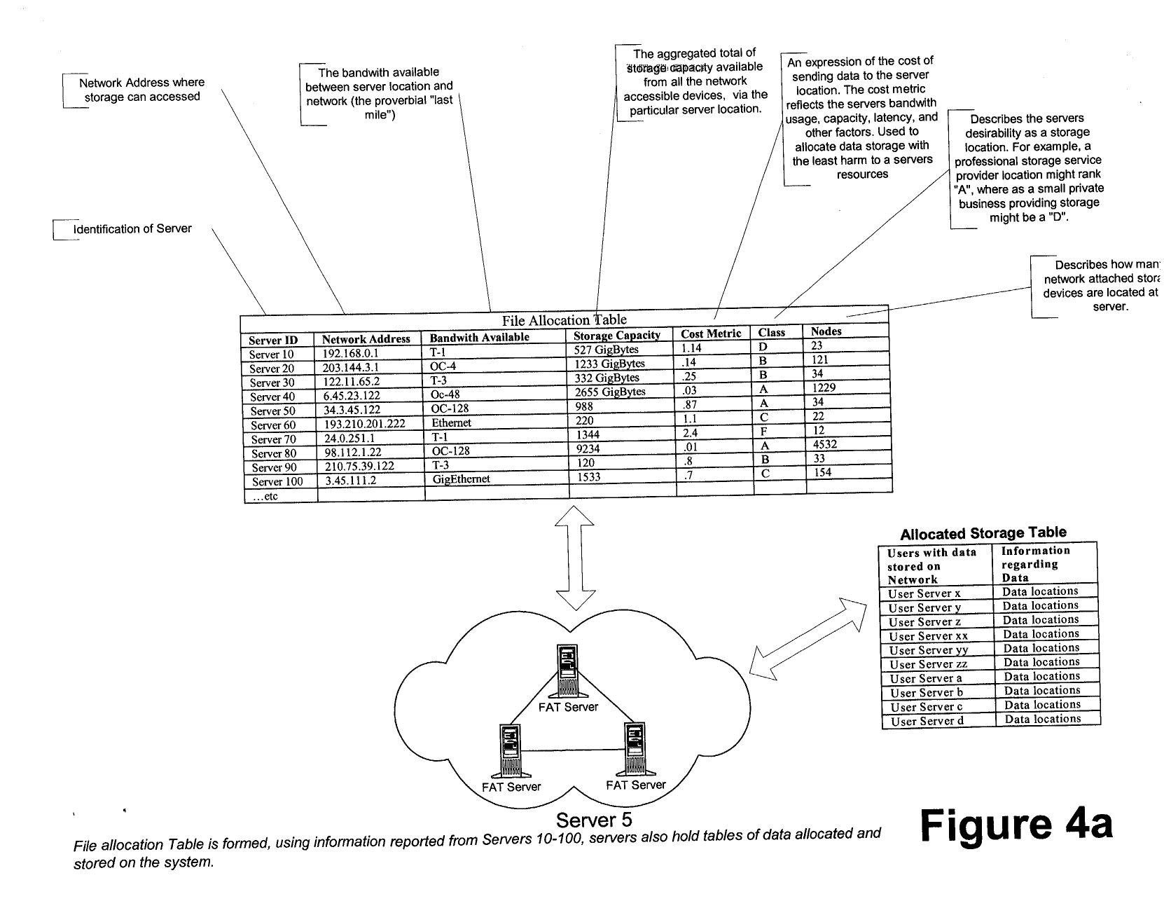

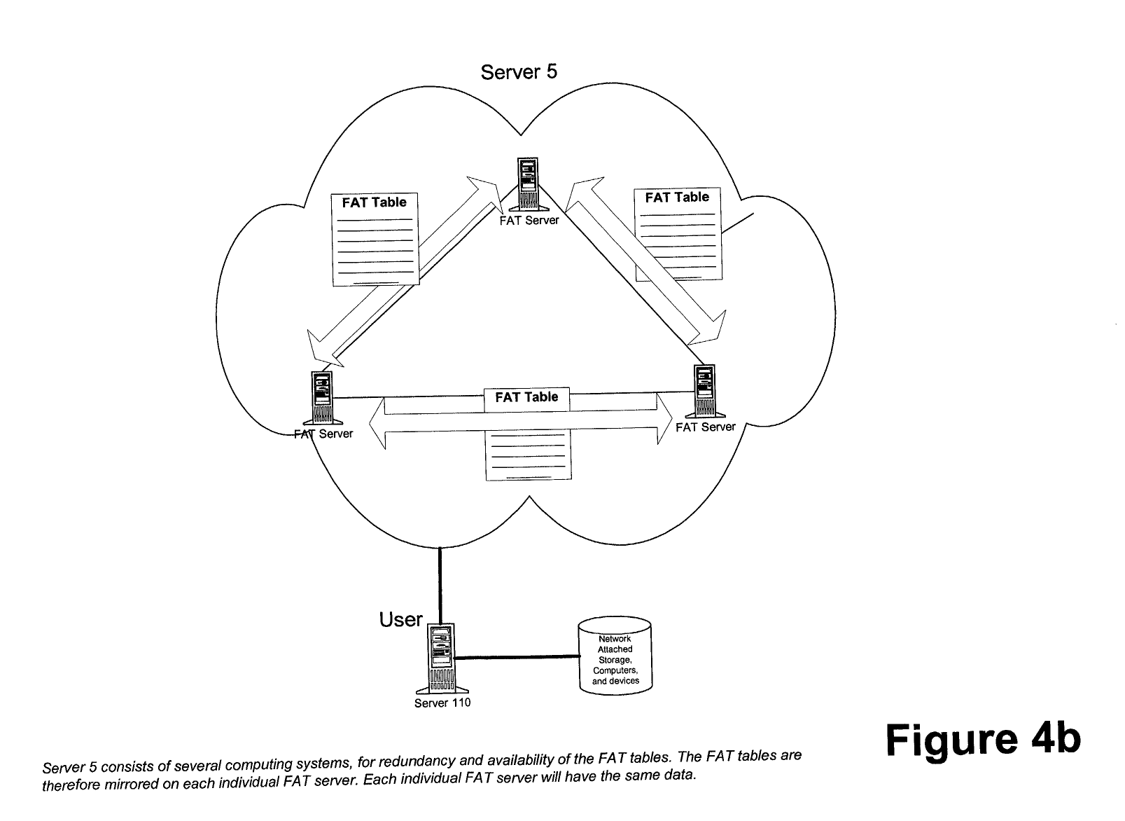

When vendor server 10 queries the network available devices on the server 10 network, or the devices report to the server (e.g., reporting can occur from device to vendor server to FAT, or through polling from FAT to server to device), a program residing on the devices issue a response to server 10. The information included in the response is then used to update the information stored on server 10 as to what resources (e.g. server, database, recordable medium, etc.) are available on the server 10 network (see FIG. 1a). When the central server 5 queries server 10, the program residing on the server 10 issues a response to the central server 5. The information included in the response is then used to update the information stored in the table. In an alternative embodiment, the servers 10-100 “log” onto the central server 5 and transmit information necessary to update the table (see FIG. 2). This embodiment will preferably be used when vendors register with the central server 5 for the first time. In this regard, each vendor registering with the central server 5 will report, for example, the corresponding IP address, storage and network capacity, and other information, which will then be stored in the table (see, for example, FIG. 4 ). The table is referred to as the File Allocation Table (“FAT”). Some of the information held in the table will be used to allocate data over the network to the server, depending on what is in the table. For example, the bandwidth capacity would be reported and stored in the table, as well as a calculation regarding what percentage of each servers network capacity is needed by the server for reasons other than the data storage service (see FIG. 4a). The table can also hold information identifying the location and ownership of data previously stored on each server. The table is then updated and revised as described above. The update takes place across various servers. Central server 5 is made up of several servers, dispersed over a network, such as the Internet, but connected to one another either over the network, or on their own network, for the purposes of mirroring the tables (the FAT tables) on each server providing the server 5 function.

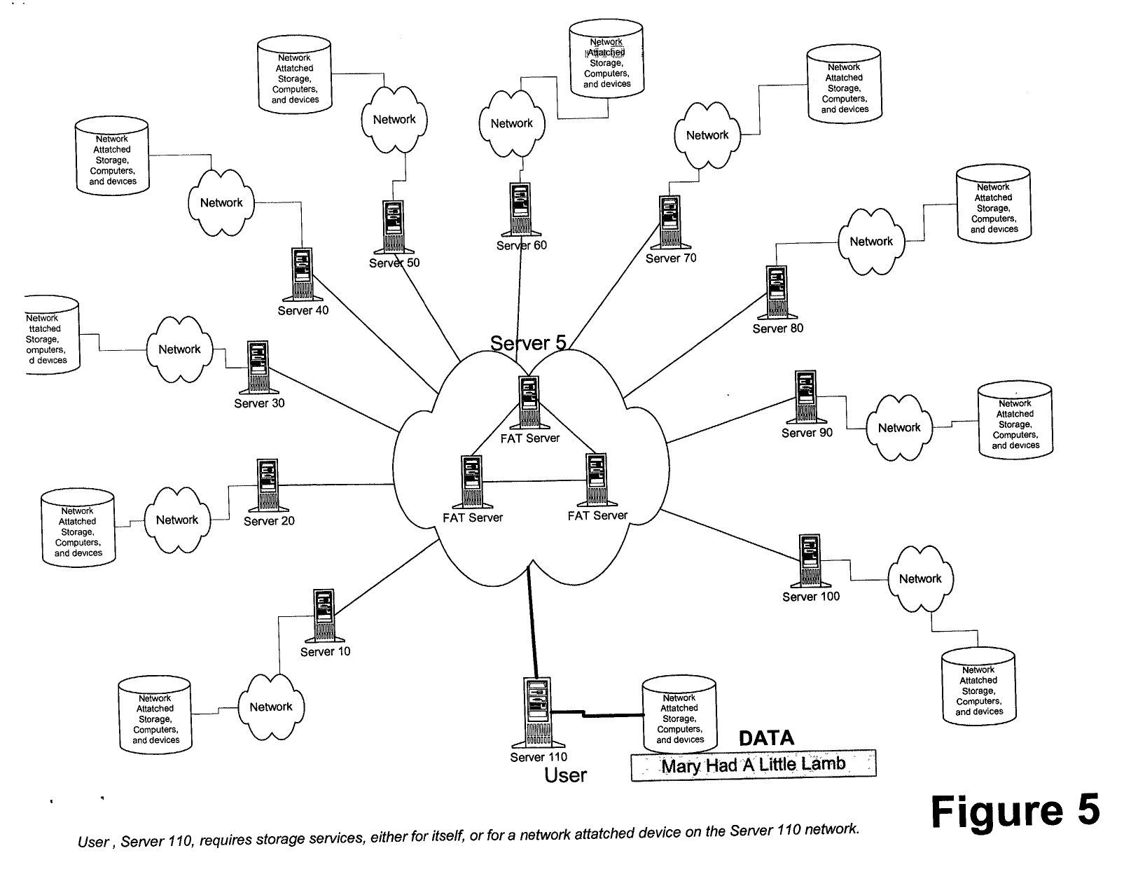

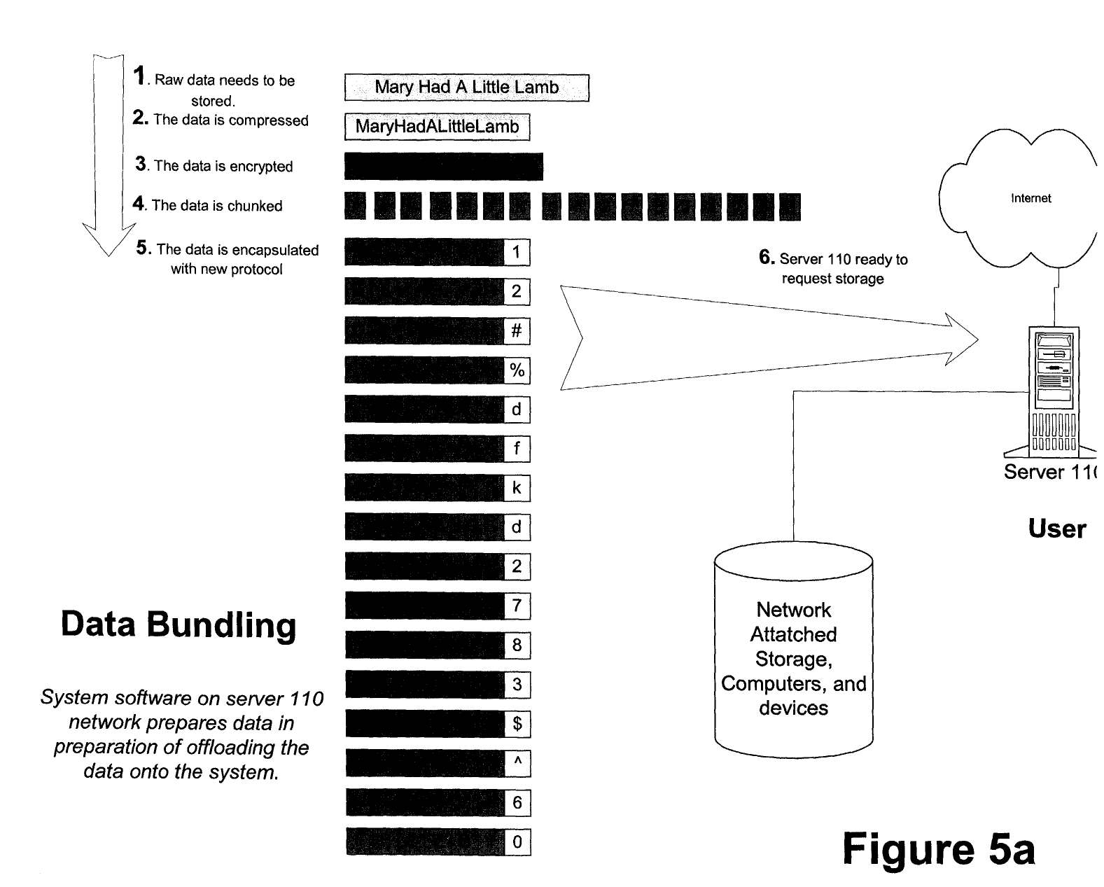

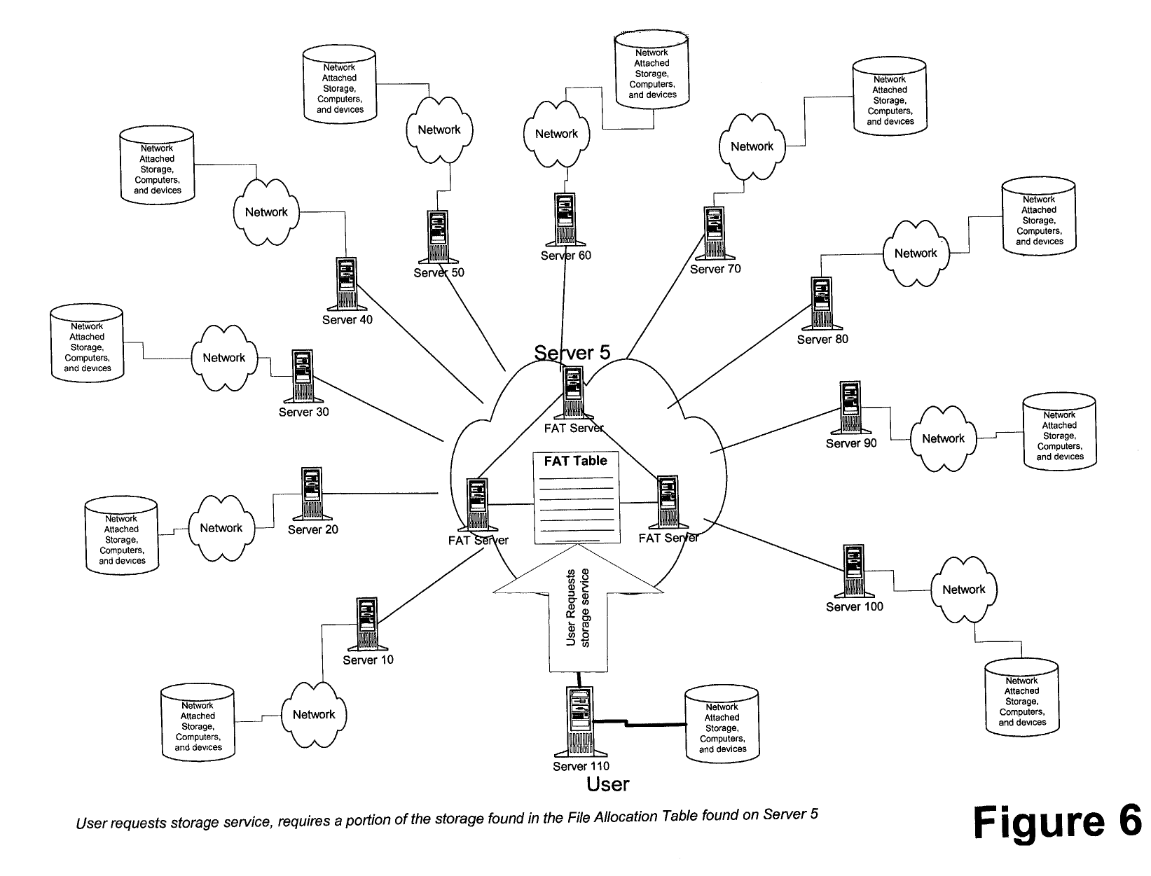

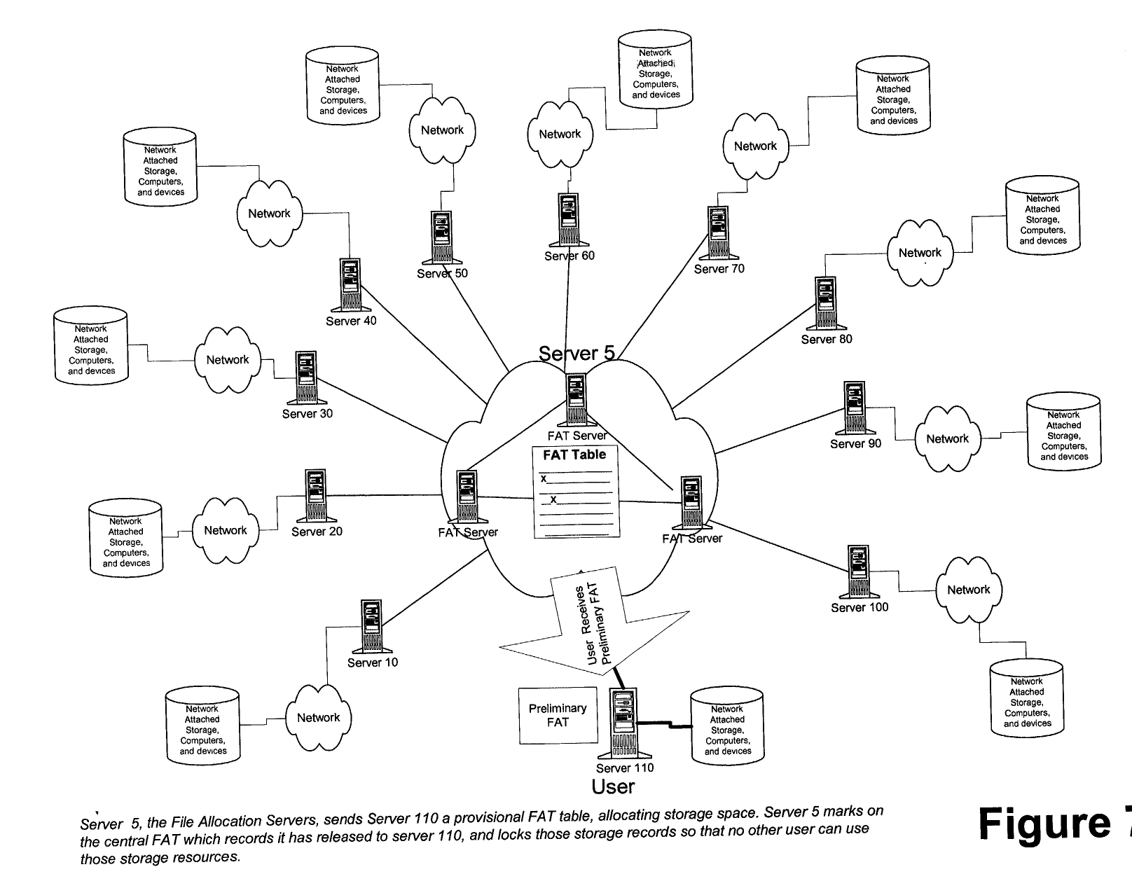

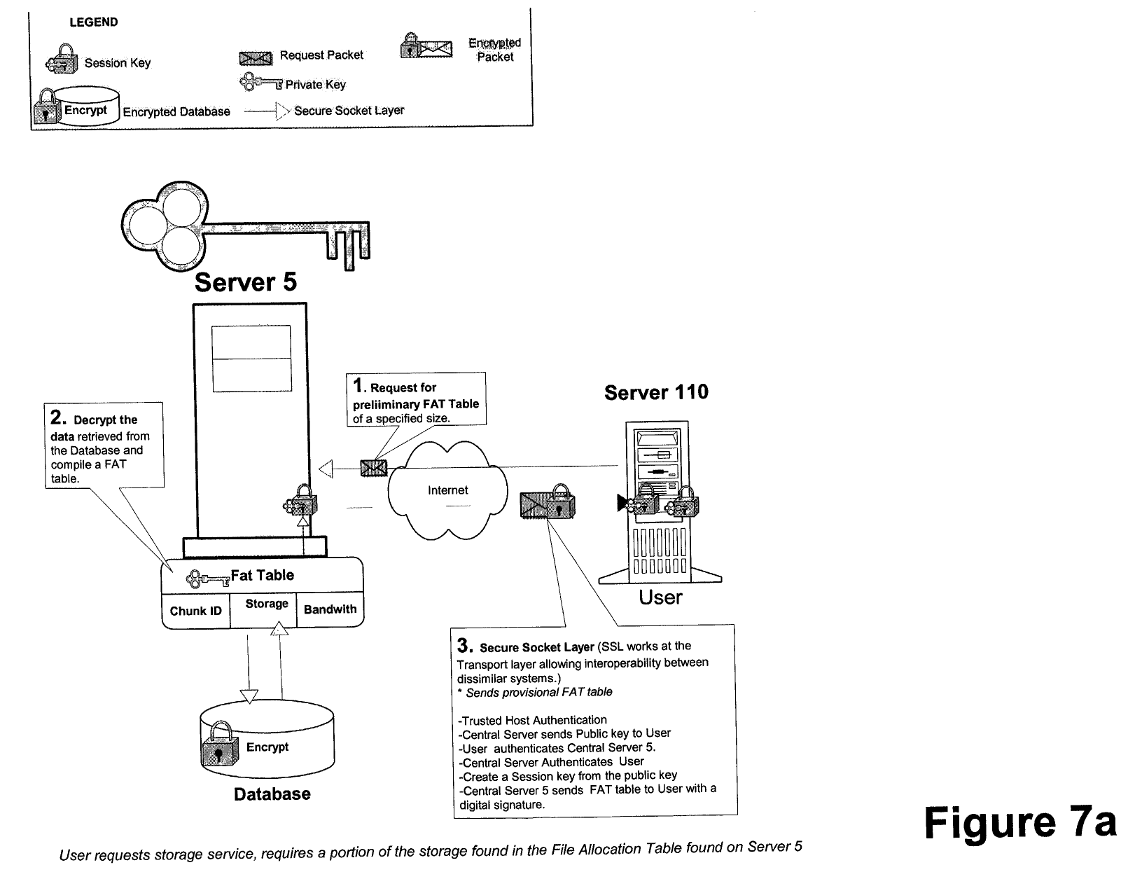

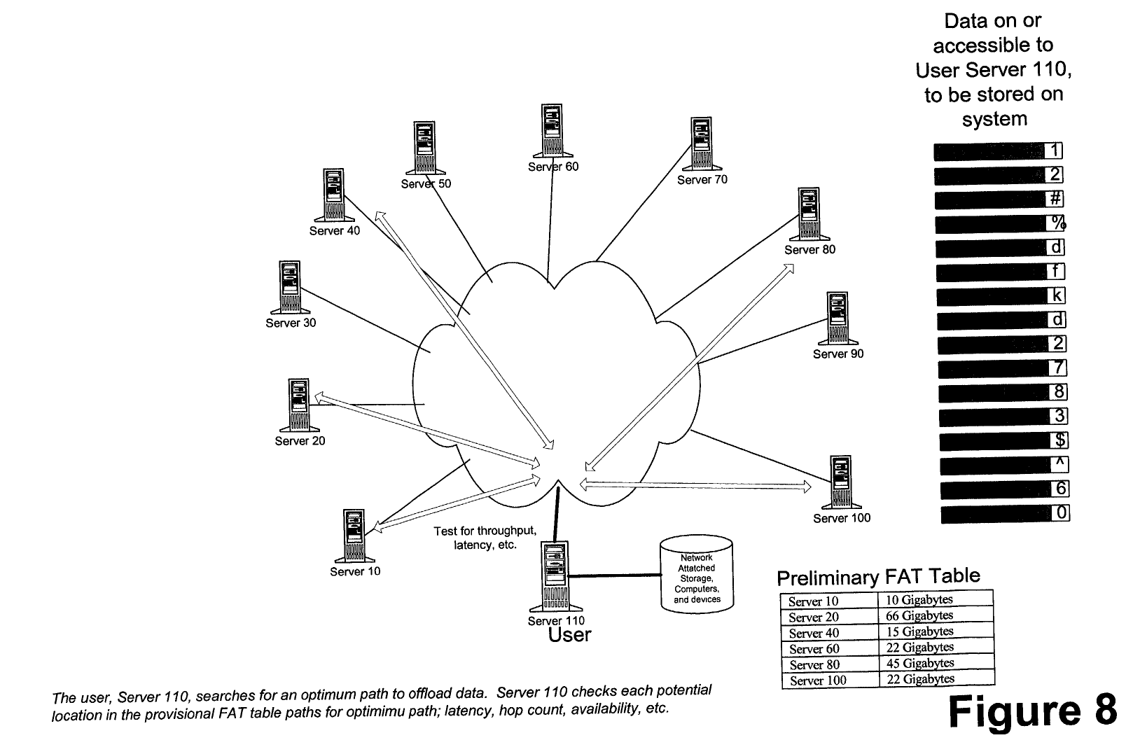

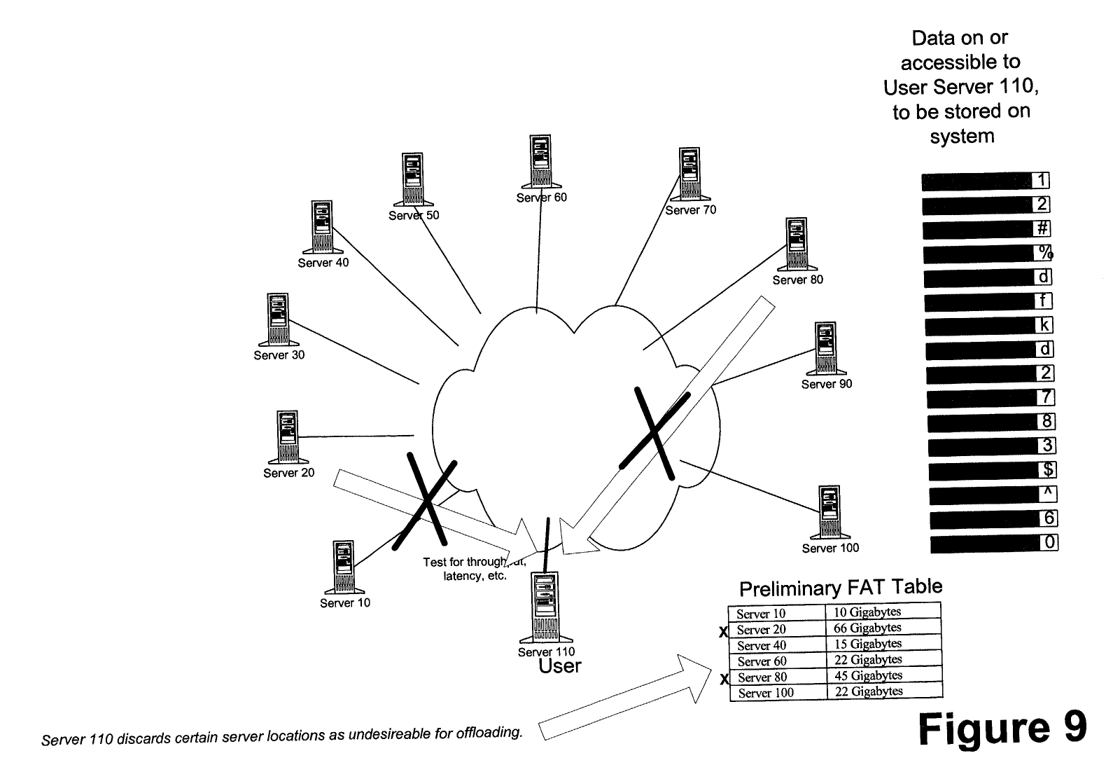

Once vendor(s) have registered with the central server 5 and a table or record has been created, clients (e.g. users) can “log” onto the central server 5 and request storage space (see, e.g., FIG. 5). A user, such as server 110, uses the software to prepare the data it needs to offload before requesting service. Server 110 accesses the data that needs to be off loaded, either locally or available to it on the network, and prepares the data (see FIG. 5a). The data is compressed, then it is encrypted, and then it is broken up into smaller pieces (“portioned”), and then encapsulated in the systems protocol. At that point, a request is made to central server 5 for storage. A preliminary table, or information from the preliminary table, is downloaded to the server pertaining to the potential offsite locations for the server's data (see FIGS. 6-7), including a list of the IP addresses of available servers. Server 110 requests the table from central server 5 using, for example a secure method, such as secure socket layer, with other security measures in place, such as authentication, and trusted host methods (see FIG. 7a), in the preferred embodiment. Central server 5 will examine the server 110 request for storage, and the characteristics required for the storage, and then examine the FAT table to prepare an optimized preliminary table for Server 110. Central server 5 will then send server 110 a preliminary table. The central server 5 supplies the available space information to the client 110 requesting information. The central server 5 request, in the preferred embodiment, will include a request for storage space that exceeds the needed amount—i.e., if 20 gigs are needed, 20+ x gigs has to be supplied for possible FAT/DNS ping, latency resolution, failed transfers etc. in order to deal with optimization issues (see FIG. 8). Some “offsite” storage locations, however, will be unacceptable to the client 110 (see FIG. 9). Hence, while the client 110 checks for the path, the central server 5 is unable to determine which offsite storage locations the central server 5 has allocated and will be used. So, the central server 5 will reserve each of the suggested locations as “reserved” until it hears back from the client 110. That is, the central server 5 will not offer those locations to any other client looking for offsite storage. Once the central server 5 receives a response from the client 110 that certain of the locations were used and others discarded, the central server 5 will update its own FAT table of available storage locations of used and available server space. A program residing on server 110 then queries the servers identified in the table for a clear path to the servers listed in the preliminary table (see FIGS. 8-9). In the preferred embodiment, there are three pieces of software that operate. Central server 5 software (referred to as the FAT server), the program on server 110 (referred to as the Internet File Server (“IFS”) software), and the application residing on the network attached of available devices (referred to as the Internet File Client (“IFC”)) . The IFS runs on server 110 or on server 40 in the preferred embodiment. The program residing on server 110 checks for latency, hop count, DNS problems, etc. to each location identified in the provisional table.

FIGS. 5-10 are an example illustrating the allocation of storage space in the servers 10-100, and the compilation of the final table to store the location of the stored data.

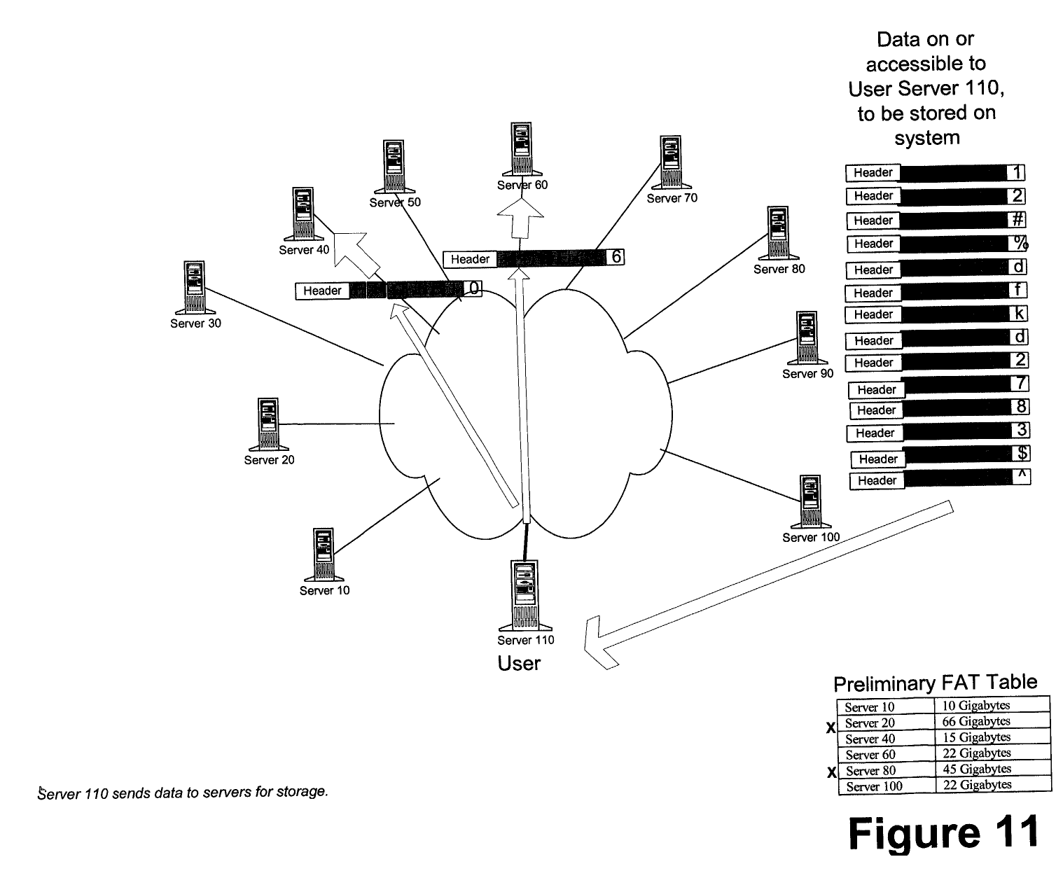

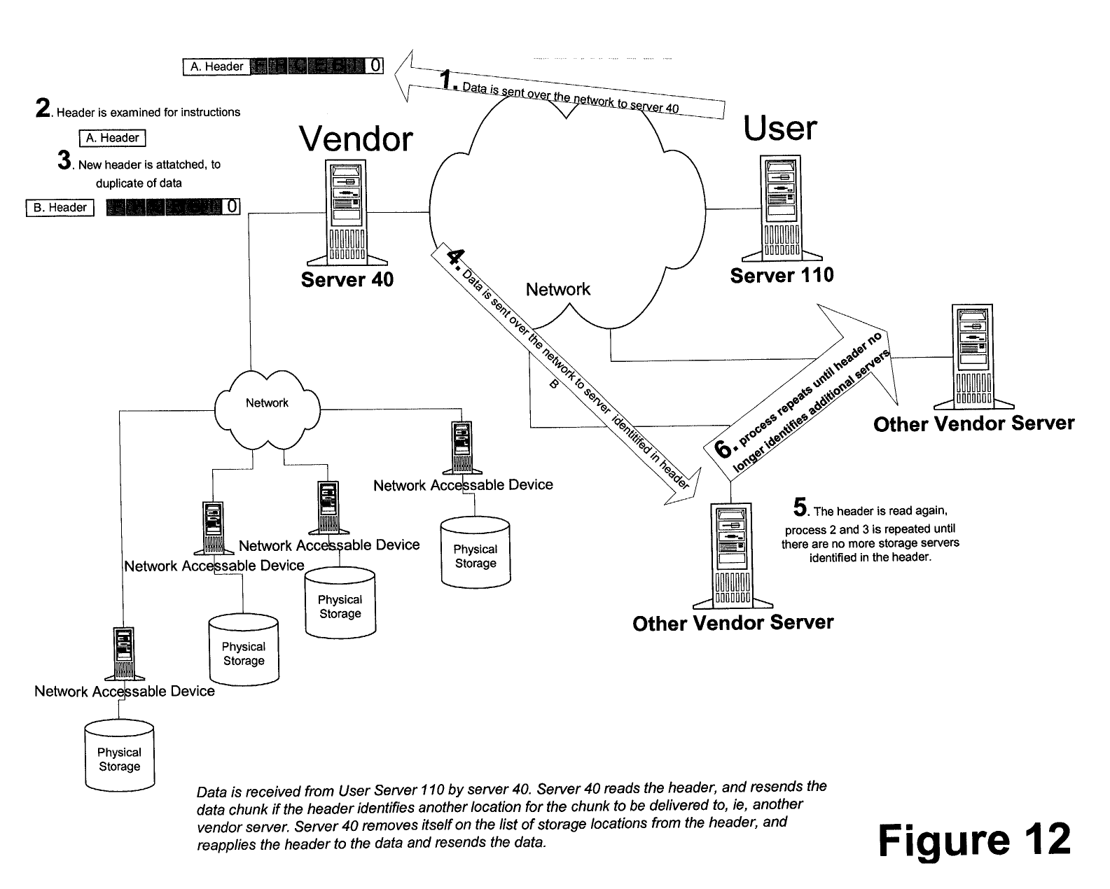

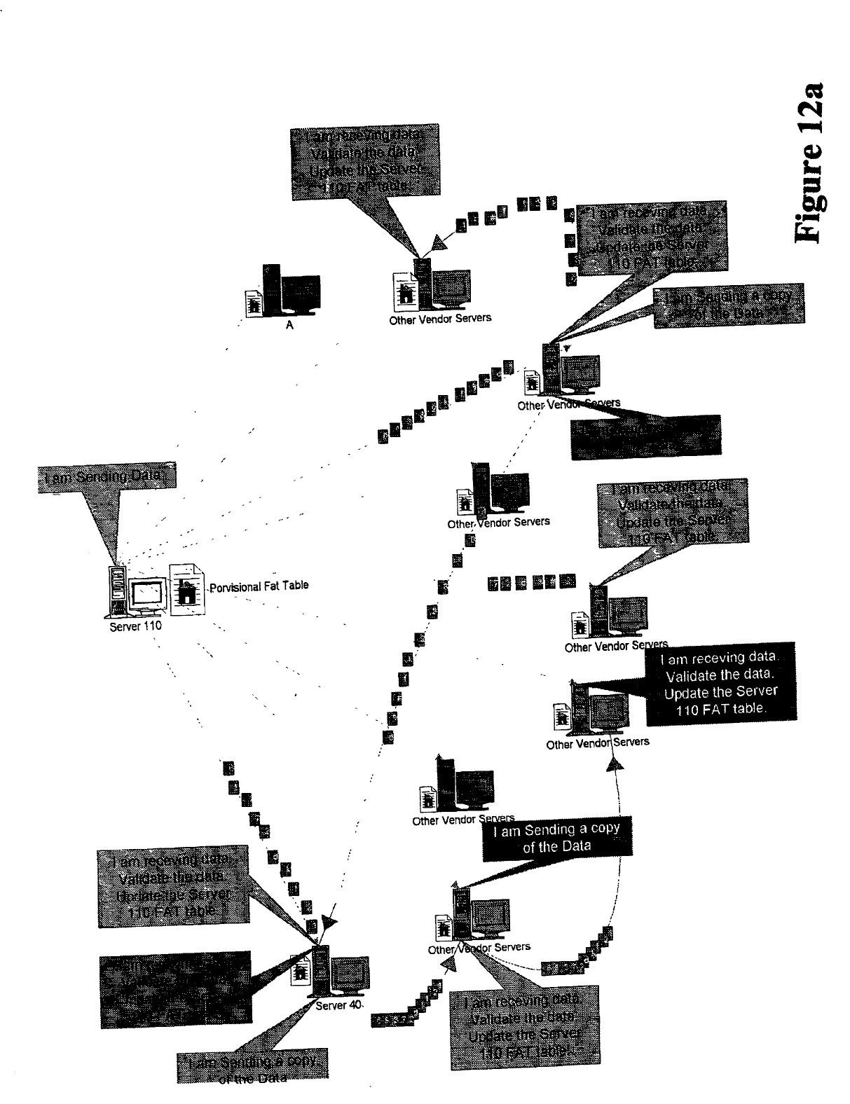

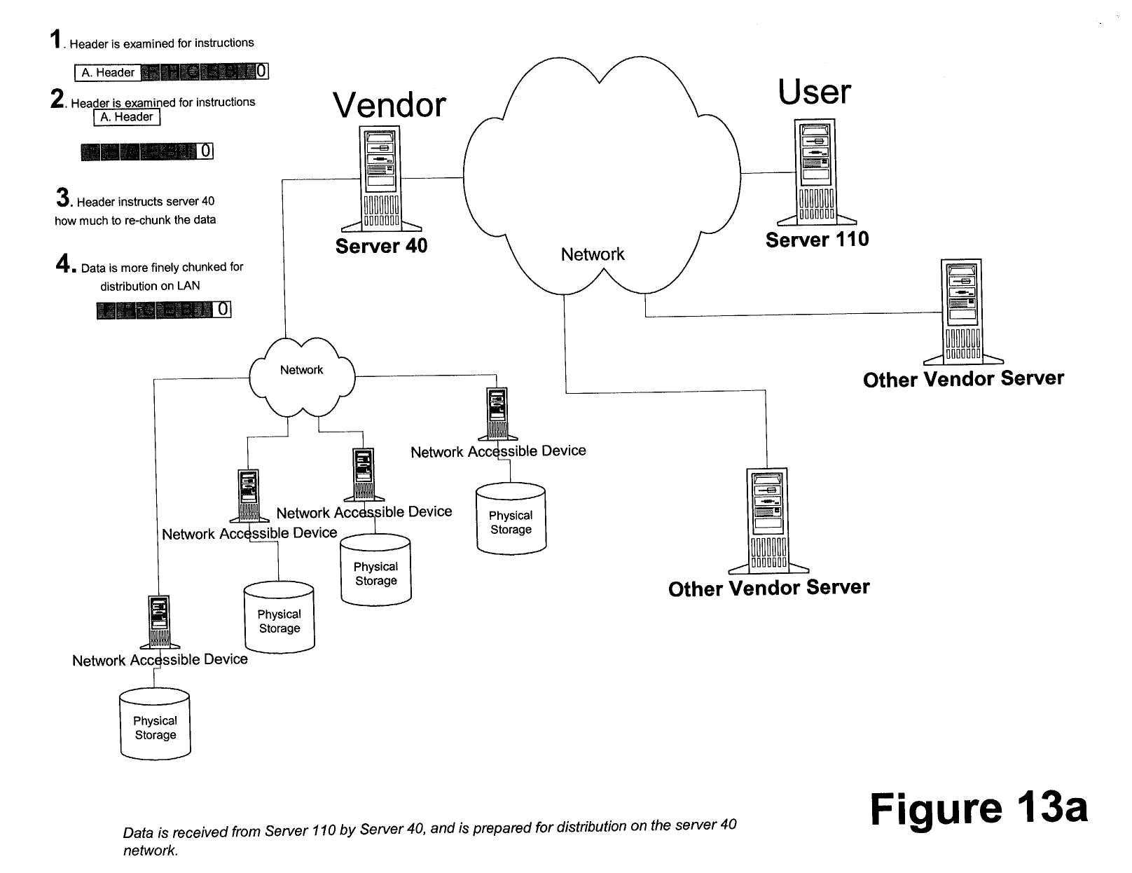

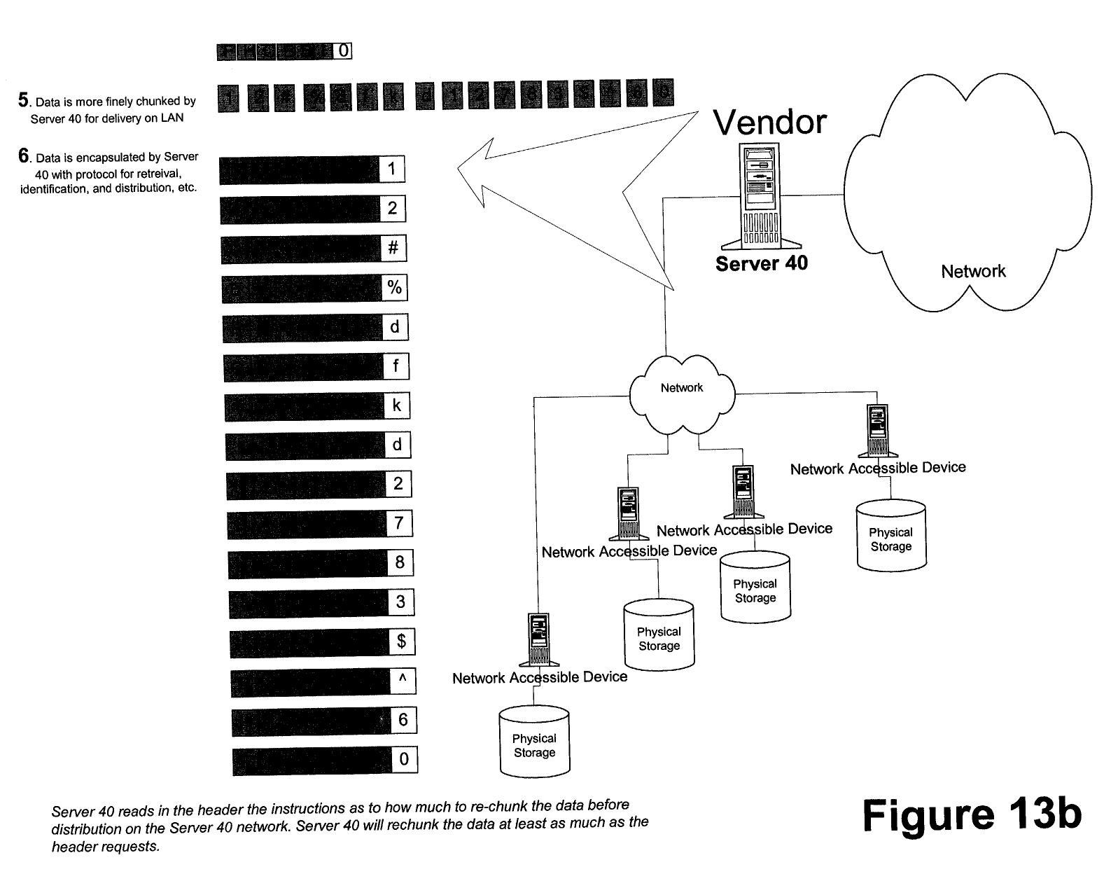

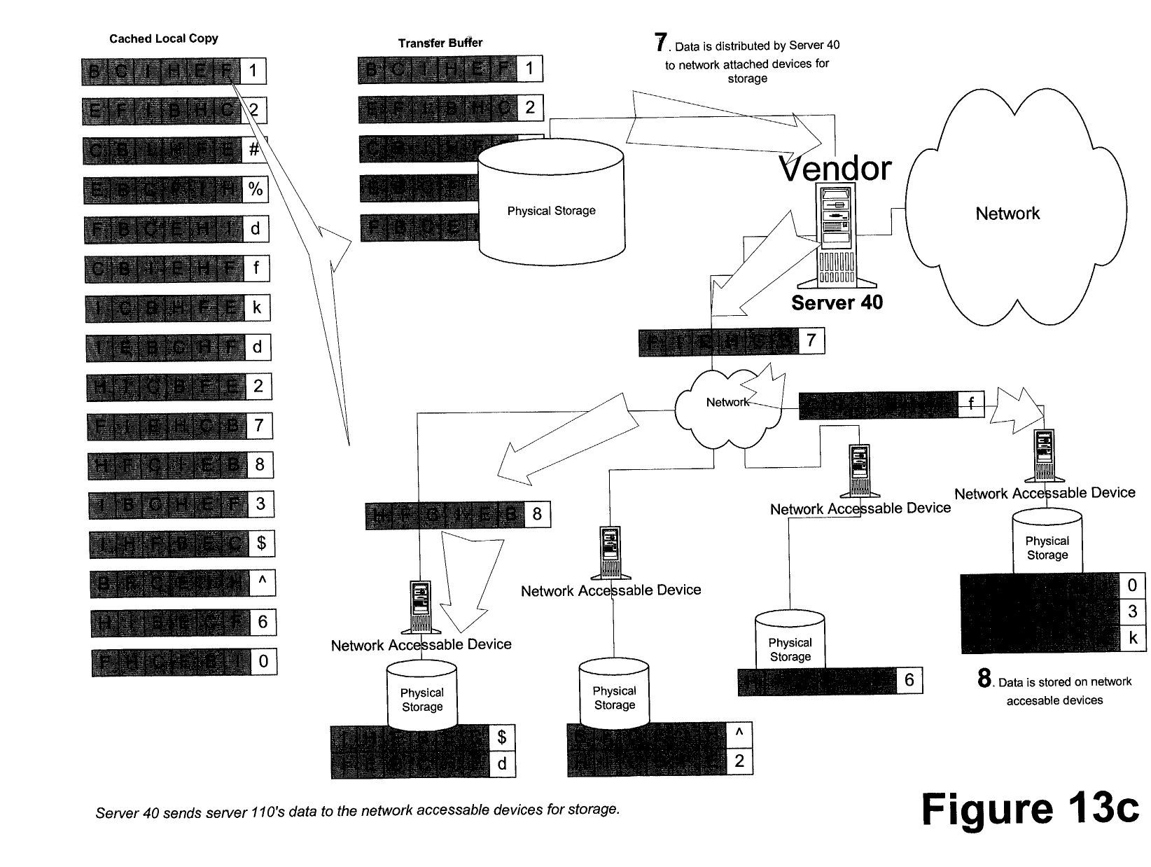

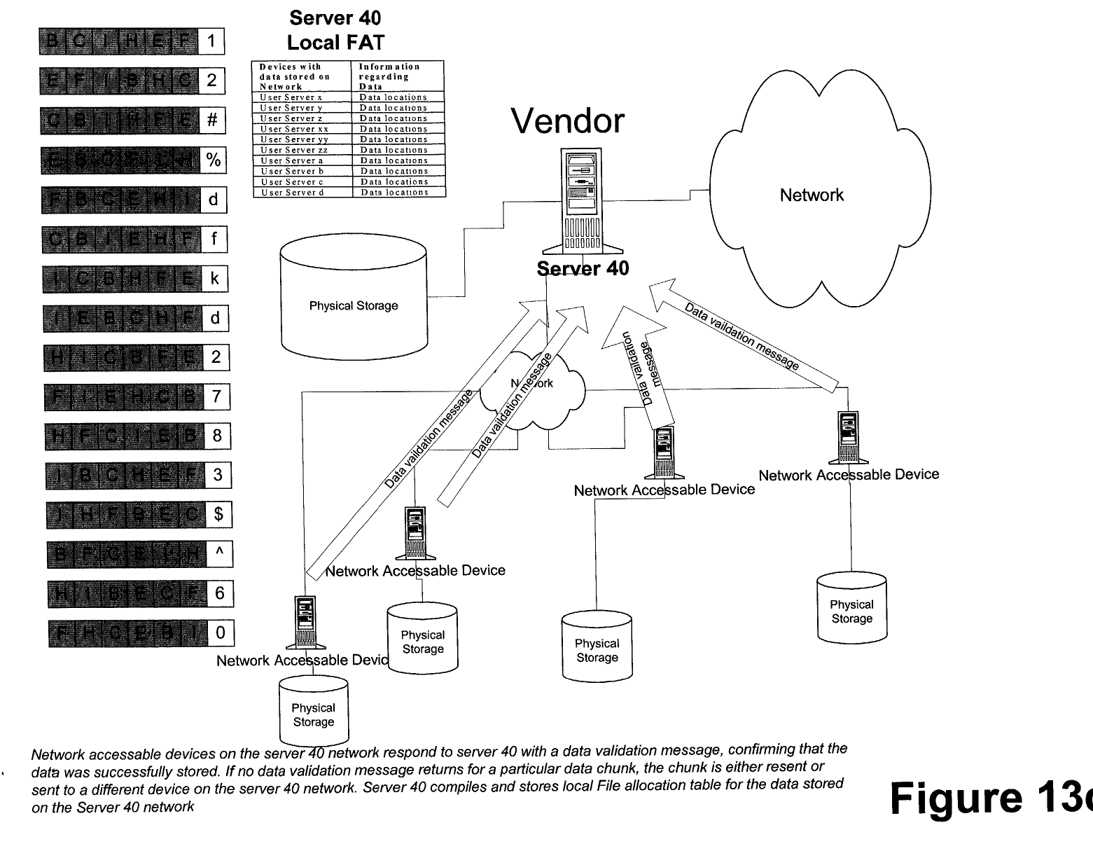

Once storage space (resources) has been requested and properly allocated, the client 110 can write data to the allocated servers 10-100. Referring to FIG. 5a, data to be sent to the servers 10-100 may first be encrypted and divided into packets of information. The packets of data may then be transmitted to the various servers 10-100 for storage, as seen in FIG. 11. When a server receives the data for storage, it reads the header encapsulating the data (see FIG. 12). The header will identify whether the data needs to be resent to another vendor. If there is another location identified in the header, the server, server 40, will take-itself out of the header (as a location for storage) and then send the data to the next server in the header. The next server will repeat the process. Server 40 will then store the data on the server 40 network, on its network accessible devices. The header also provides instructions for server 40 on how to handle the storage on the server 40 network. For example, the header might instruct server 40 to break the data into portions, in the preferred embodiment, up to about 5 megabytes before distributing the data onto the server 40 network. FIGS. 13a-e shows a portion of server 110 data being re-portioned and redistributed on the server 40 network.

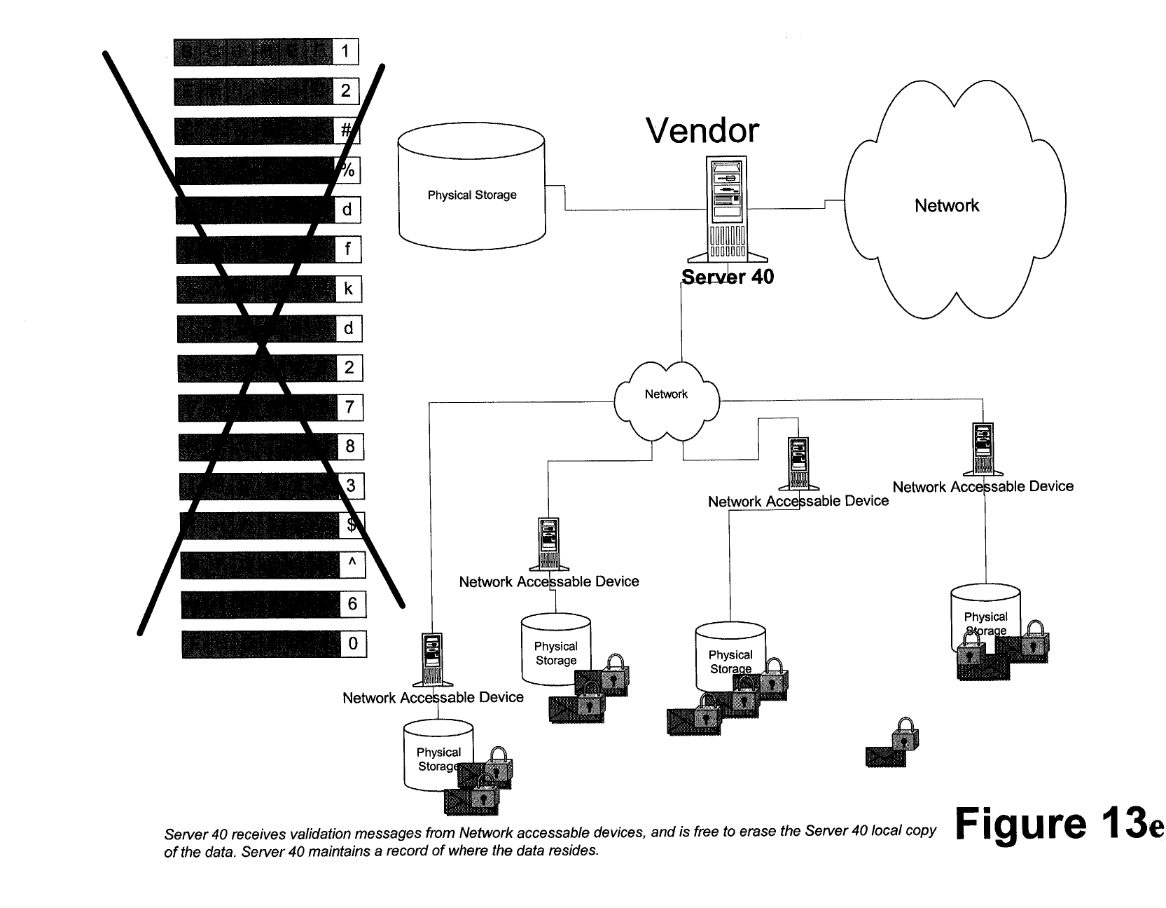

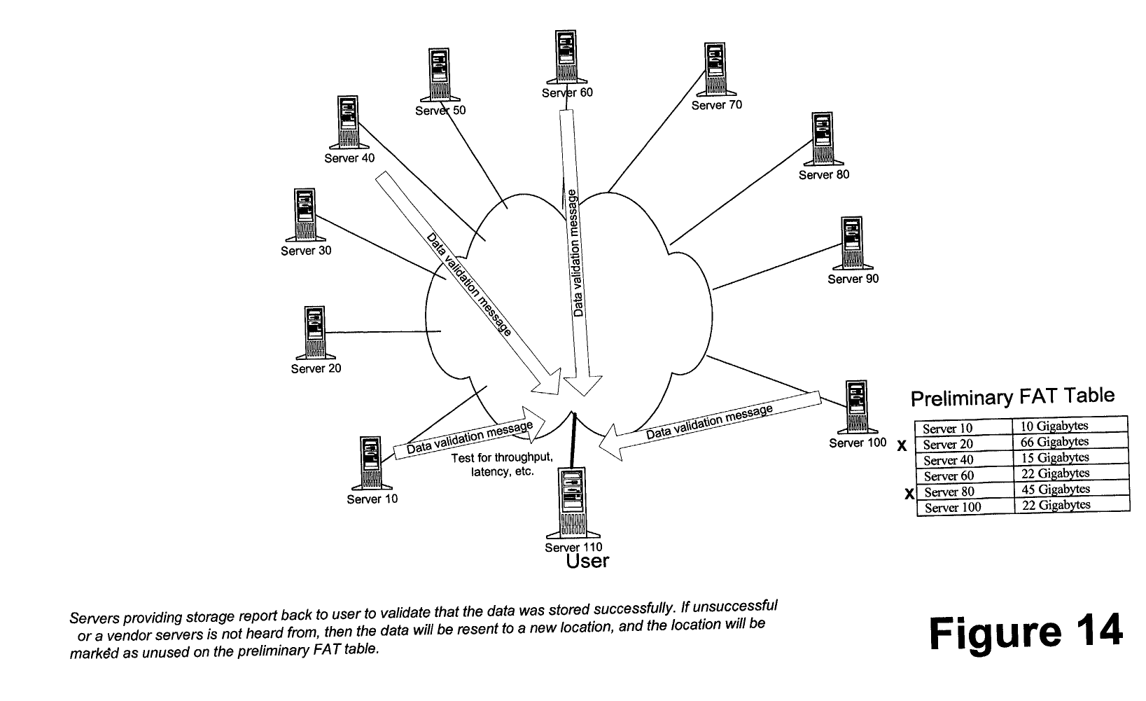

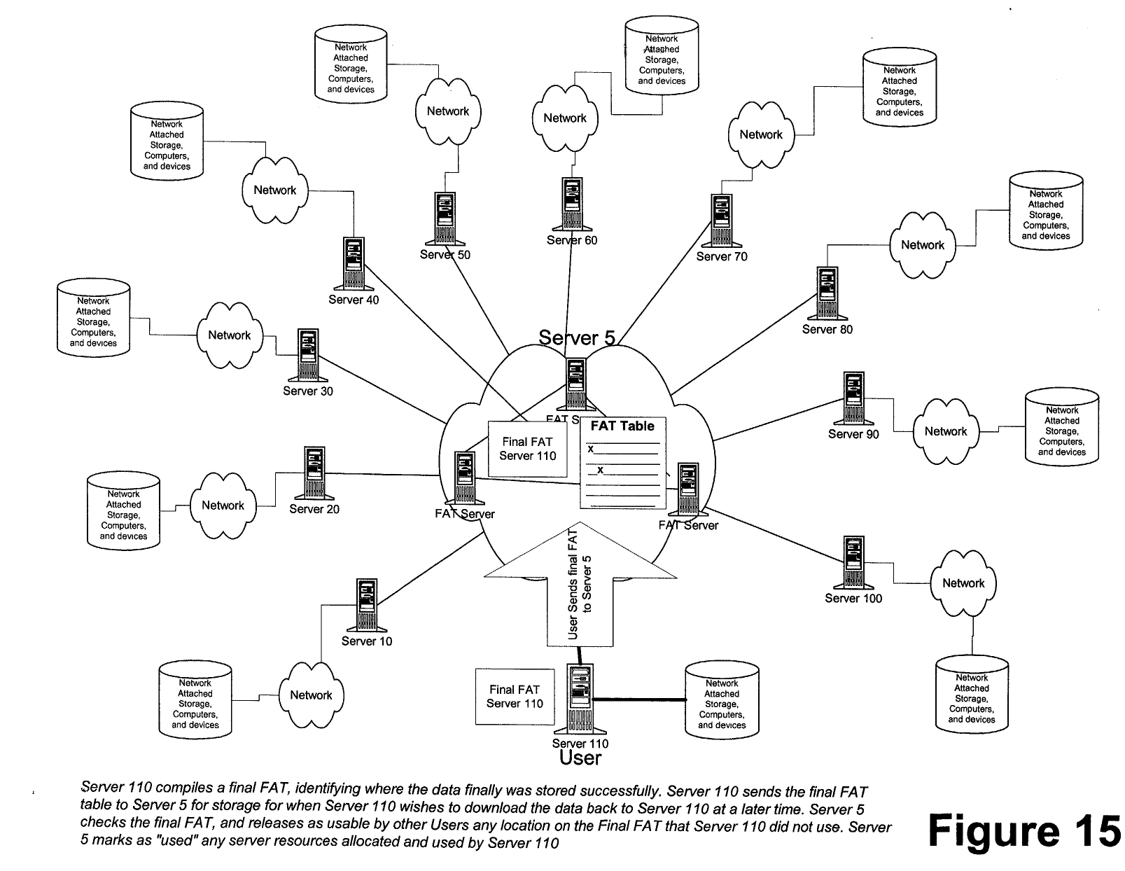

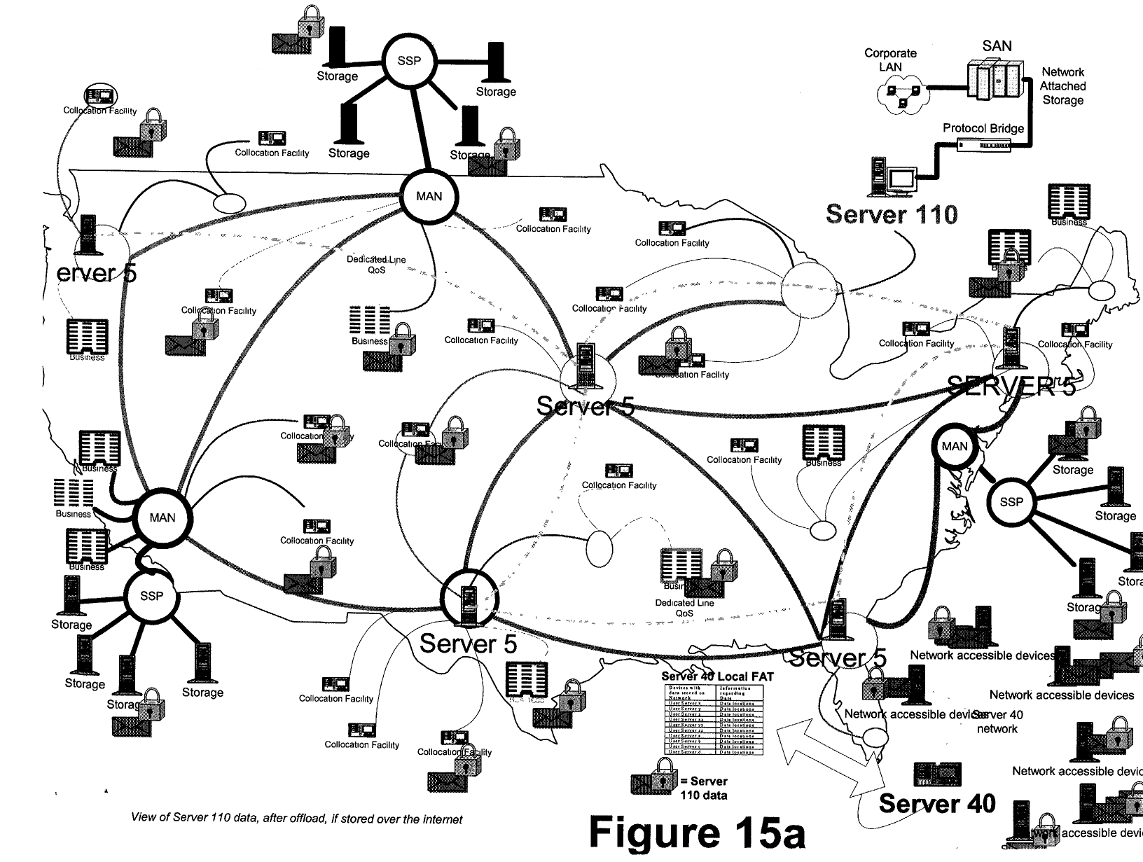

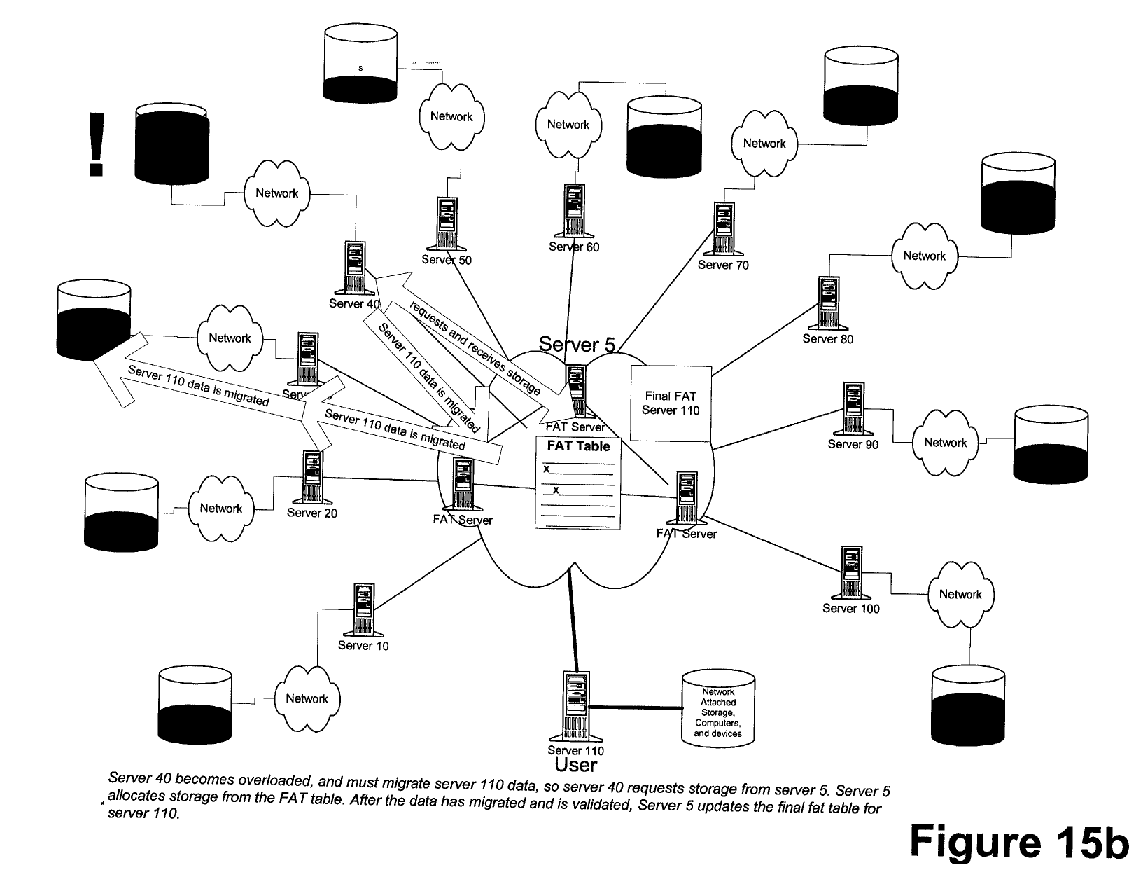

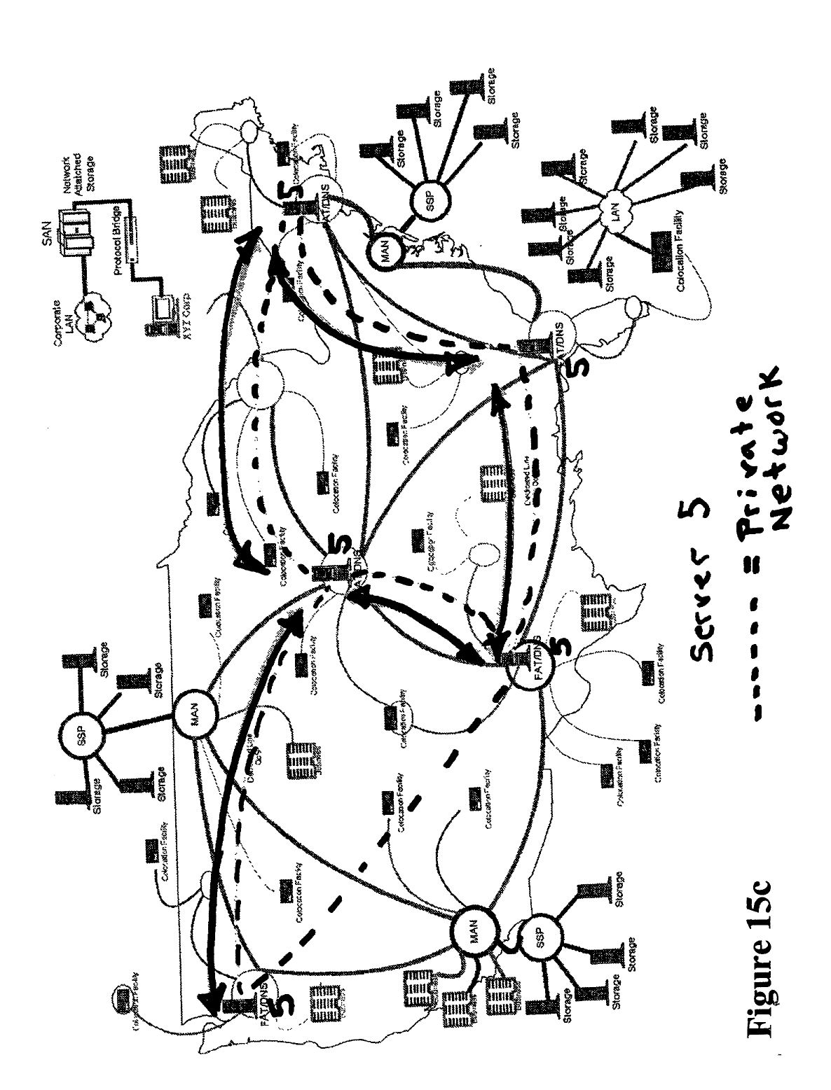

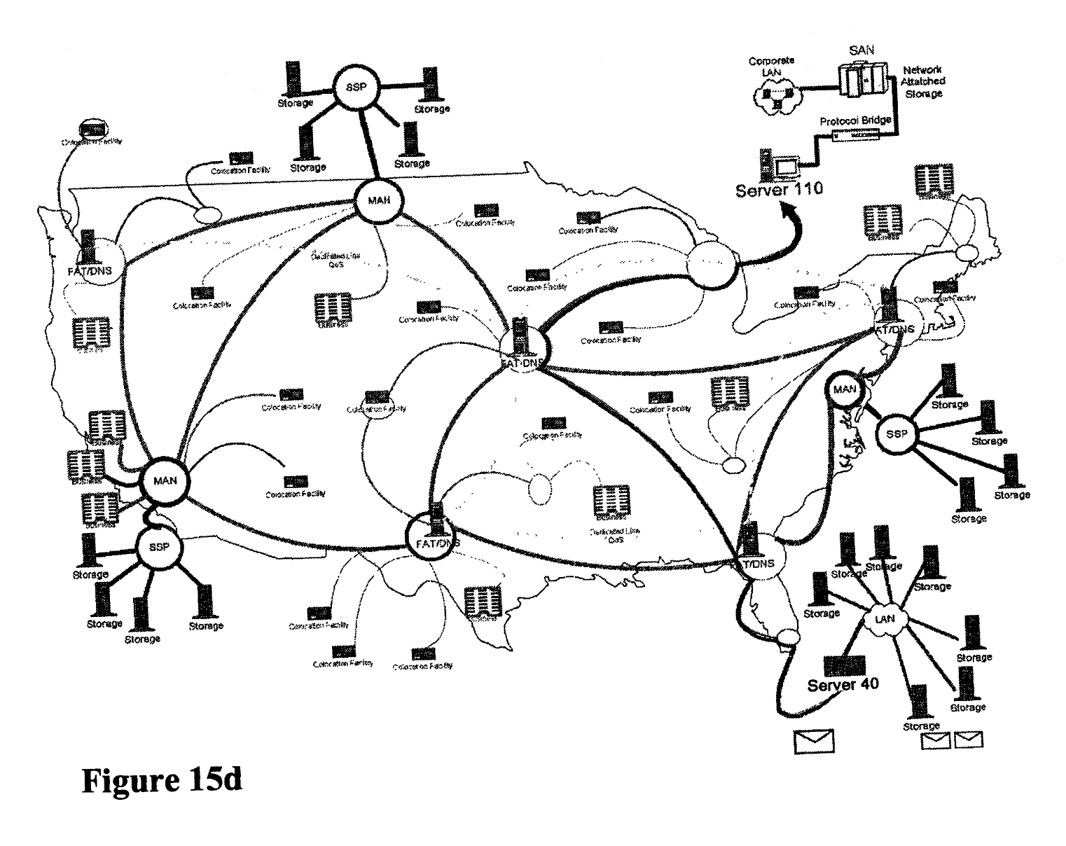

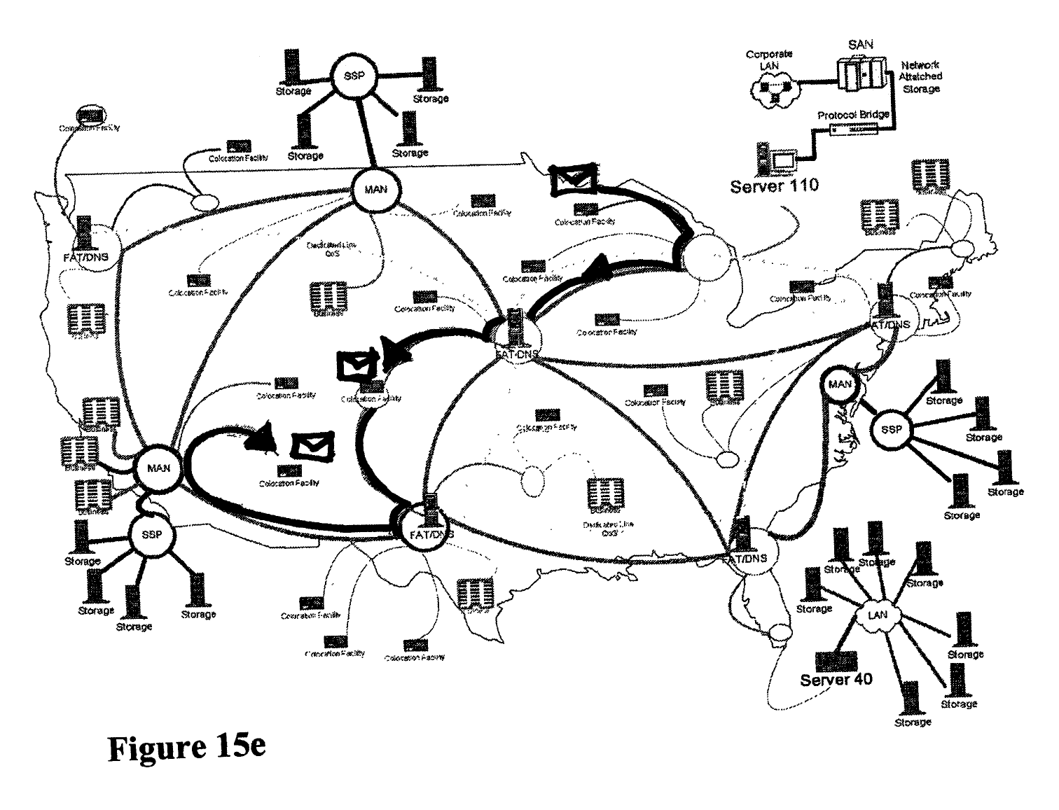

After server 40 has received a validation message from the network accessible devices on the server 40 network that were sent data (see FIG. 13d), server 40 compiles a table of where the data is located, and then server 40 can erase the server 110 data portion stored locally on server 40 (see FIG. 13e). One having ordinary skill in the art will recognize that the data may be kept locally, on server 40, and not distributed, or stored on the cache on another intermediate machine—such as an “edge server”. Server 40 then sends a data validation message to server 110, signifying that the data it was sent has been successfully stored (see FIG. 14). Server 110 will receive a data validation message from each server identified in the data portion headers; both from the servers that were directly sent the data, and the other vendor servers that were to be sent data from servers (see FIG. 12). If server 110 does not receive a data validation message, server 110 will choose another location from the preliminary FAT table (See FIG. 14), and resend the data. When server 110 has finished off loading all of its data, server 110 sends a table , the final FAT table, identifying the resources successfully used by server 110 (see FIG. 15). Central server 5 will then store the server 110 final FAT tables on central server 5. Central server 5 will also reallocate as “usable” any storage locations on the various servers that server 110 did not use. FIG. 15a is an example of what the stored data looks like in one embodiment, where the network is the Internet. If a server 10-100 exceeds capacity, while the data resides on the system, the data will be returned to the central server 5 and rerouted to another server.

FIG. 15b illustrates a request for of floading data from a server 10-100 by the central server 5, where the server 10-100 informs the central server 5 that a certain capacity of storage remains. FIGS. 5-15 are then repeated, if necessary. If the data is of floaded, it only needs to be copied once, not many times as in the previous embodiments. The vendor servers may use this process when they suddenly find themselves in need of offsite storage—e.g., for emergency backup, etc. Storage need is flburstyfl for vendor servers. In this regard, the software program that the vendors would host has a user configuration setting allowing the vendors to determine how much of their space is available. Vendors may, for example, have only 5% left of their storage capacity, enterprise wide, empty, and then find themselves with four mail servers getting flooded, for example, with emails. In this case, the vendors would have nowhere to put the excess data they are receiving, and so some data has to be sent offsite in a hurry. One having ordinary skill in the art will appreciate that any server technology or any storage medium could be used to implement the invention.

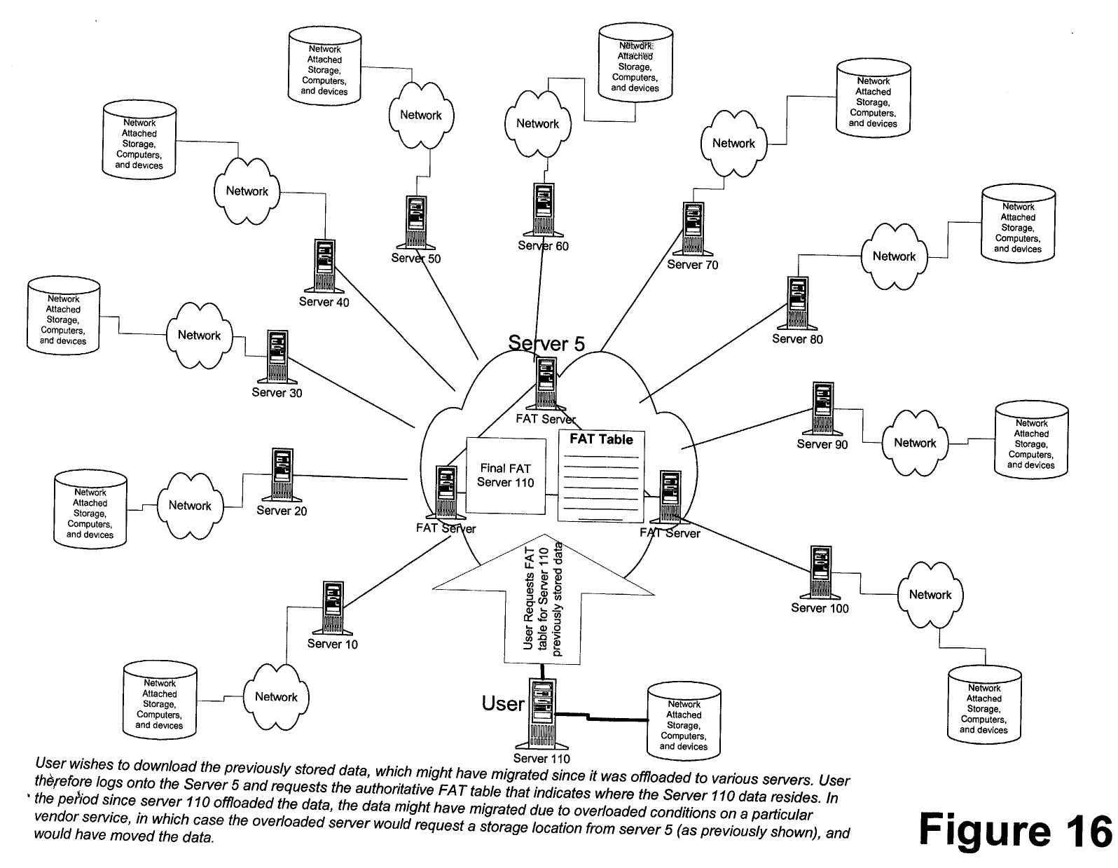

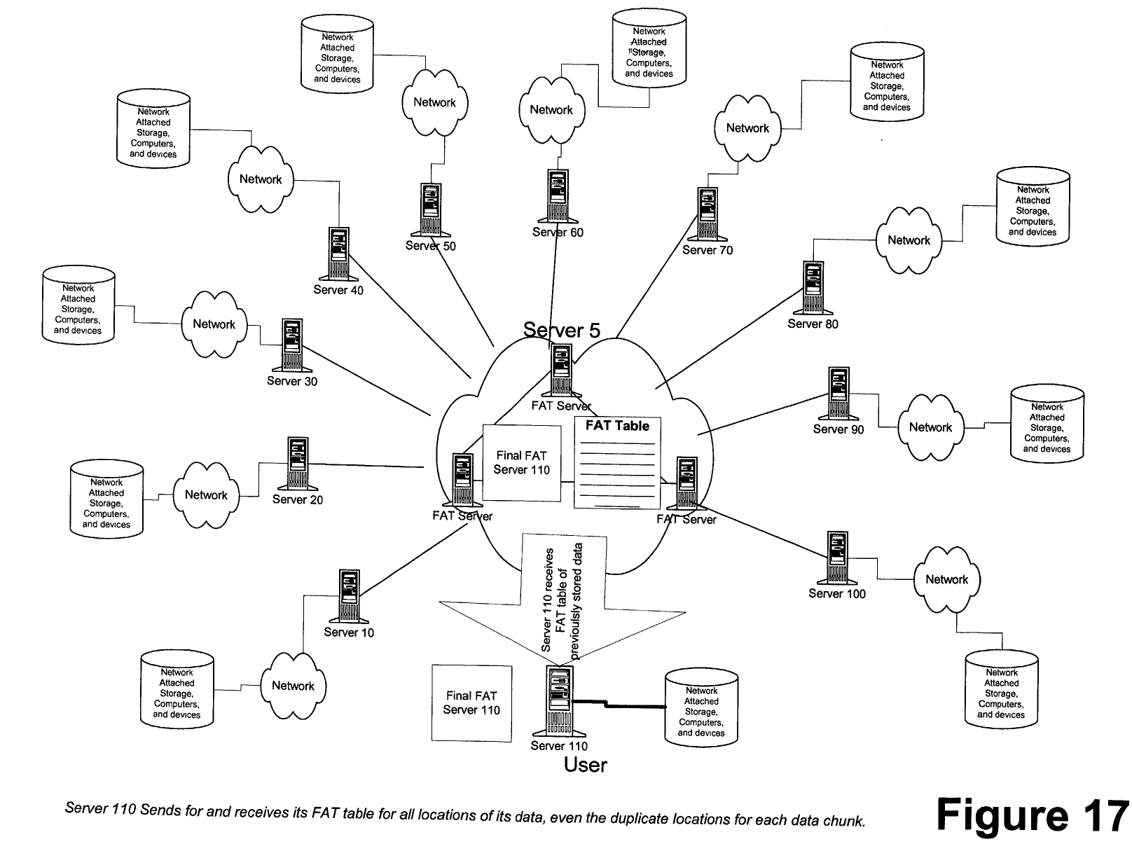

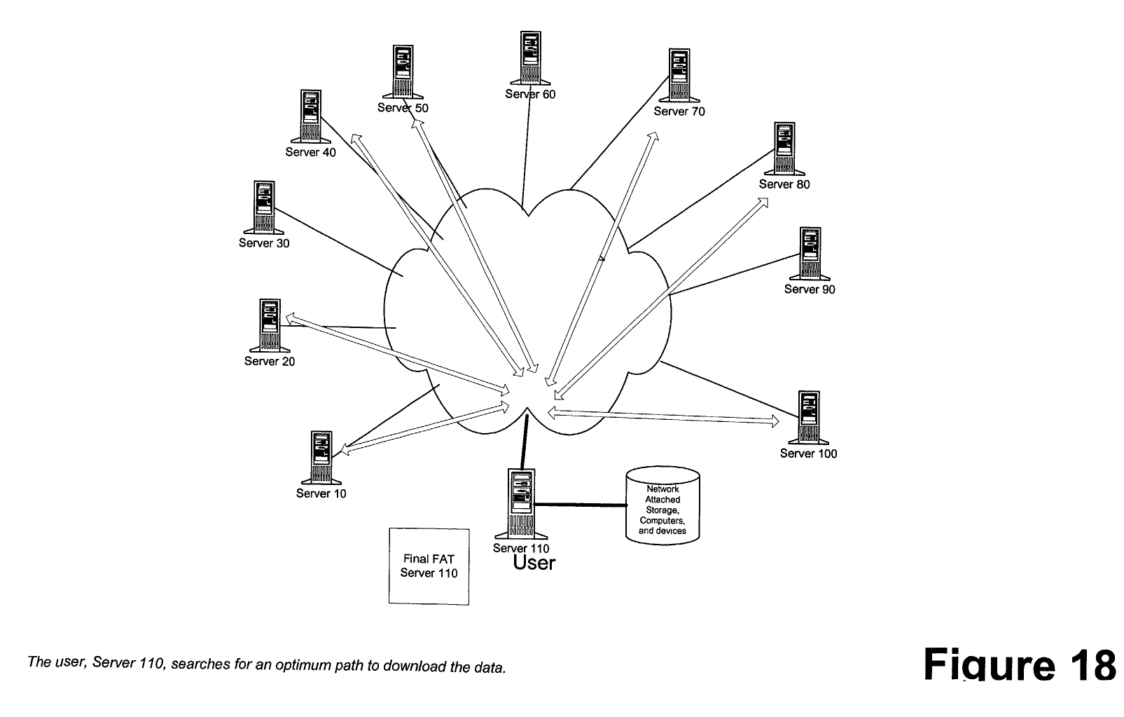

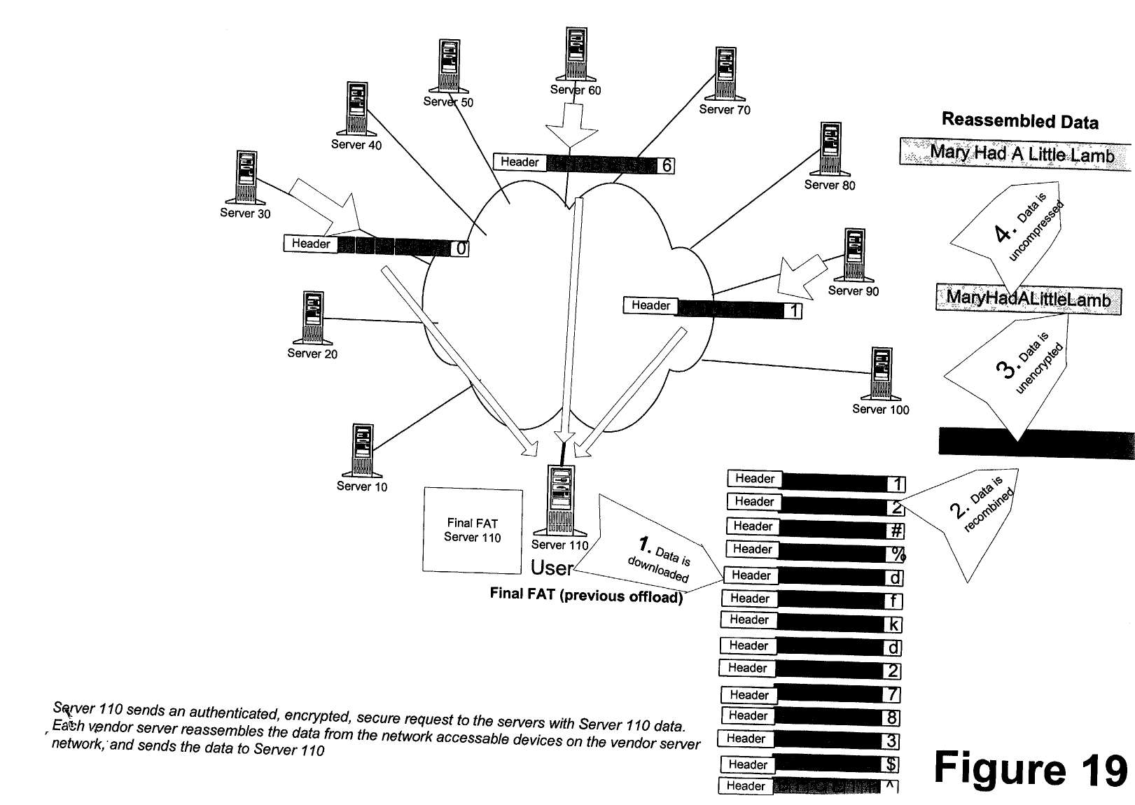

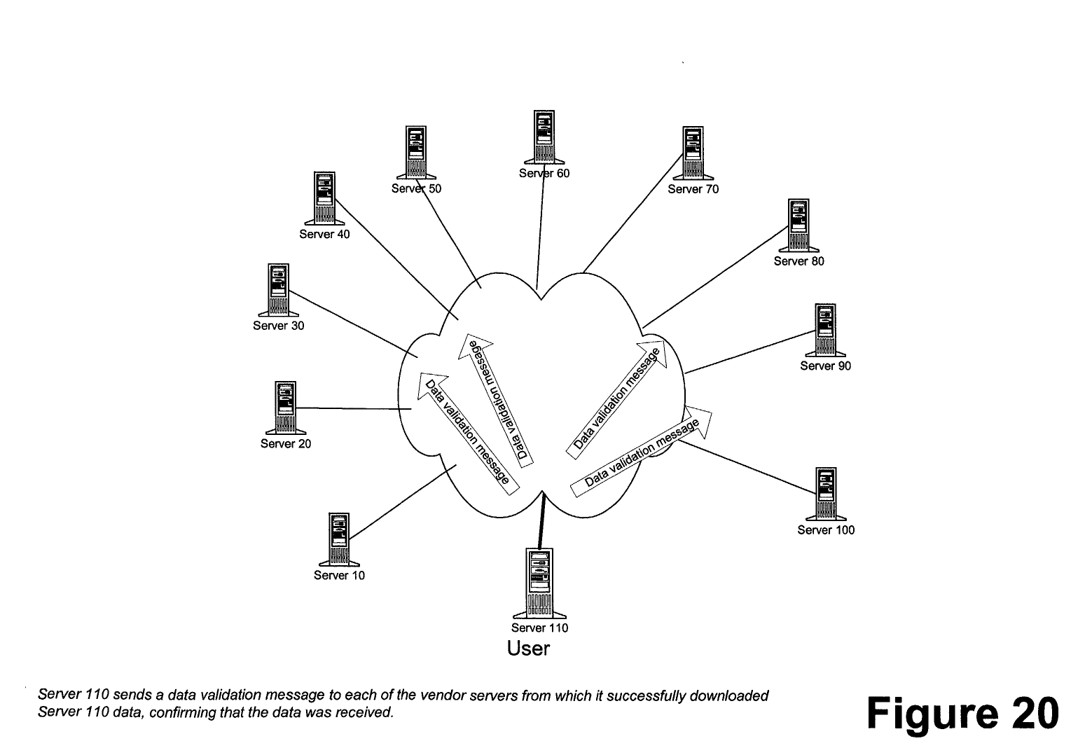

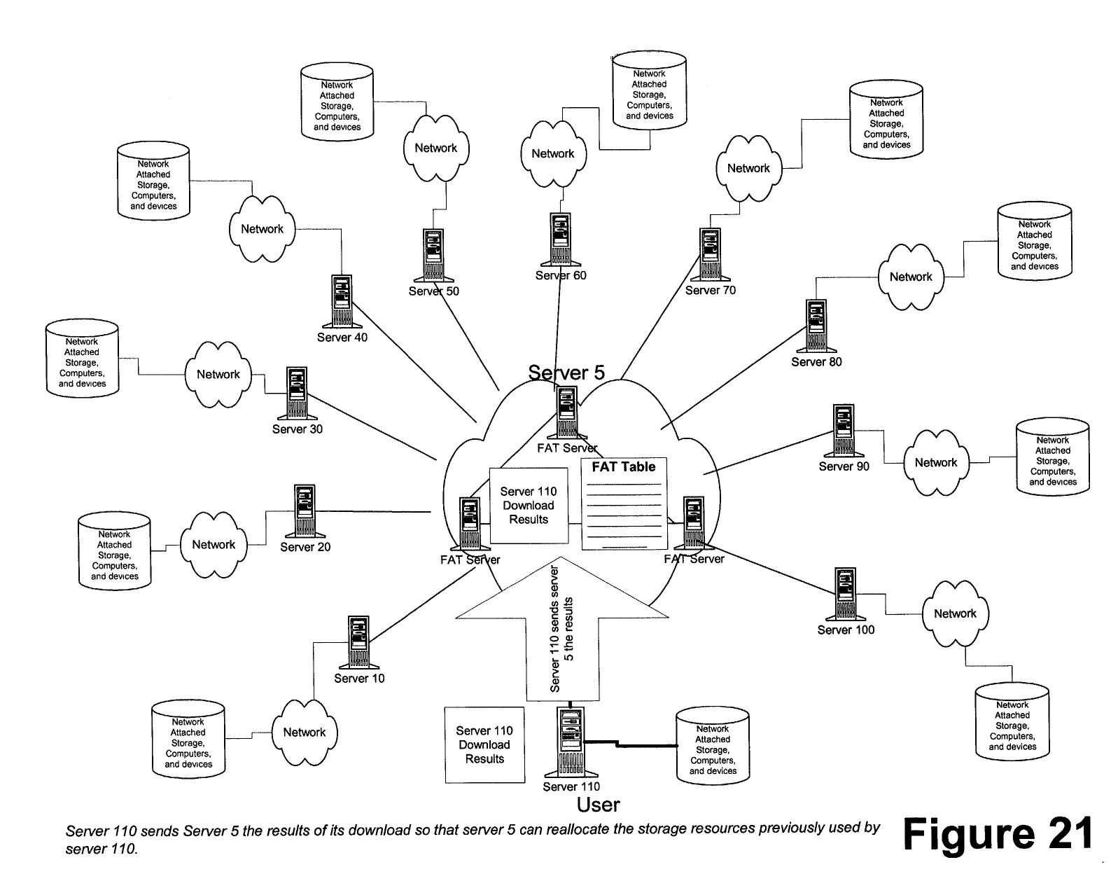

As data is stored and/or moved from server to server, the final FAT server 110 table will be updated to reflect the change of location, etc. When server 110 requests information that has been stored, the central server 5 accesses the final FAT server 110 table, and sends the table to server 110, which retrieves the corresponding data stored on the servers 10-100. The final FAT server table is then updated to reflect the retrieval of data from the respective servers 10-100. In FIGS. 16-17, server 110 requests downloading previously stored data. Or, in FIGS. 16-17, an authenticated server with server 110's authentication privileges requests downloading the stored data (through access to server 110's private key via Public-Private key encryption). Server 110, or a user with 110's privileges, requests the server 110 final FAT table from central server 5 (see FIG. 7a). Alternatively, server 110 might have a cached local copy of its final FAT server table, having been kept updated by central server 5, or the other servers, as to where the data resides. Server 110 will then search for an optimum path to download its data, and choose one location from each of the locations that each data portion is stored. Server 110 sends a request to each server, for example servers 30, 60 and 90 in FIG. 19, in a similar manner as shown in FIG. 7a, e.g., the connection is authenticated, encrypted, and conducted over a secure method such as secure socket layer. Each server storing server 110 data then uses its local FAT table identifying where server 110 data resides, and uses the table to reassemble the server 110 data, from the locations where server 110 data resides on each network accessible devices-server 30 for example. Server 110 then reassembles the data, as shown in FIG. 19. The data is downloaded, recombined, unencrypted, and uncompressed, and then delivered to the application residing on the server 110 network requesting the data. Server 110, after it has successfully recombined the data, sends an data validation message to the servers that had been storing server 110's data (see FIG. 20). As in FIGS. 21-23, server 110 will upload the results of its data retrieval process to central server 5, which will notify each server, allowing the servers to reallocate their storage resources, either back to the system, or for their own applications. Central server 5 will then update the FAT table to reflect the newly required storage resources, which can now be used by the system.

It is readily understood by one having skill in the art that other embodiments of this invention could exist. For example, central server 5 may be replaced by a computer or any other means, such as by a PDA, mobile phone, etc. Various preferred embodiments of the invention have now been described. While these embodiments have been set forth by way of example, various other embodiments and modifications will be apparent to those skilled in the art. Accordingly, it should be understood that the invention is not limited to such embodiments, but encompasses all that which is described in the following claims.

What is claimed is:

1. A method of storing data on a network, comprising:
identifying available resources located on a network; and
allocating storage space on at least one identified resource on the network for storage of data.

2. The method of claim 1, further comprising:
indicating the amount and location of resources available on the network;
creating a file allocation table identifying the storage available on the network resources; and
sending the file allocation table to the identified resources, and reserving storage space on a respective resource based on the file allocation table.

3. The method of claim 2, further comprising:
searching for the data path to upload data based on at least one of latency, hop count and availability;
discarding undesirable resource locations for uploading; and
sending data to the identified resources for storage.

4. A method of distributing data across a network, comprising:
searching the network resources for available storage space;
allocating network resources based on a file allocation table created as a result of the search; and
sending the data to the allocated resources for storage.

5. The method of claim 5, wherein the resources include servers connected to the network and the file allocation table includes at least information regarding the availability and location of the resources.

6. A method of retrieving data stored at multiple locations on a network, comprising:
requesting a file allocation table including the location of stored data;
searching for a data path to retrieve the data;
sending a request to each location having data stored thereon; and
reassembling the data at the multiple locations.

7. The method of claim 6, wherein the data includes header information identifying at least where the data is to be sent.

8. A method of storing data on a network at a different location from a client requesting storage, comprising:
receiving data from a user server and examining header information in the data for instructions;
replacing the header information with new header information; and
sending the data over the network to at least one server identified on the network in the header information.

9. A system for storing data over a network, comprising:
a client requesting resources for storing data over the network;
a central server processing the request from the client and allocating resources to the client for storing the data; and
a vendor server for storing the data, the vendor server being selected by the central server based on the processing.

10. The system of claim 9, wherein
the central server identifies which vendor server has space available for storing the data, and
the vendor server indicates to the central server the availability of space on the server.

11. The system of claim 10, wherein
the central server includes a file allocation table to store at least information about the availability and
location of resources on the network for storing data, and the vendor server stores at least a first portion of the data, and another vendor server stores at least a second portion of the data.

12. A system for allocating resources on a network to store data, comprising:
a plurality of servers to store data; and
a central server identifying at least one of the plurality of servers to store the data,
the plurality of servers residing at a location different from the location from which data storage is requested.

13. The system of claim 12, further comprising:
a client requesting the storage of data on at least one of the plurality of servers located at a different location,
the central server creating a file allocation table to store at least information about the availability and location of the plurality of servers.

14. The system of claim 13, wherein the file allocation table is created based on information supplied by the plurality of servers to the central server.

15. The system of claim 13, wherein the vendor server is connected to a local network, the vendor server using resources on the local network for storage of the data.
